(19) United States
(12) Patent Application Publication
(10) Pub. No.: US 2025/0052711 A1
(43) Pub. Date: Feb. 13, 2025

(54) SENSORS AND RELATED SYSTEMS AND METHODS

(71) Applicants: Massachusetts Institute of Technology, Cambridge, MA (US); Analog Devices, Inc., Wilmington, MA (US)

(72) Inventors: Brian L. Wardle, Lexington, MA (US); Luiz H. Acauan, Somerville, MA (US); Yosef Stein, Sharon, MA (US); Haim Primo, Ganei Tikva (IL); Haozhe Wang, Pasadena, CA (US); Aniruddha Ghosh, Cambridge, MA (US)

(73) Assignees: Massachusetts Institute of Technology, Cambridge, MA (US); Analog Devices, Inc., Wilmington, MA (US)

(21) Appl. No.: 18/719,520

(22) PCT Filed: Dec. 14, 2022
(86) PCT No.: PCT/US2022/052780

§ 371 Date: Jun. 13, 2024

Related U.S. Application Data
(60) Provisional application No. 63/289,596, filed on Dec. 14, 2021.

(51) Int. Cl. G01N 27/24; B82Y 15/00; G01N 27/22

(52) U.S. Cl. CPC G01N 27/24; B82Y 15/00; G01N 27/226; G01N 27/228

(57) ABSTRACT

The present disclosure is related to sensors, such as structural sensors, and related systems and methods.

### RELATED APPLICATIONS

This application claims priority under 35 U.S.C. § 119 (e) to U.S. Provisional Patent Application No. 63/289,596, filed Dec. 14, 2021, and entitled “Wireless Sensors and Related Systems and Methods,” which is incorporated herein by reference in its entirety for all purposes.

### TECHNICAL FIELD

Sensors, such as structural sensors, and related systems and methods are generally described.

### SUMMARY

The present disclosure is related to sensors, such as structural sensors, and related systems and methods. Certain embodiments are related to sensors (e.g., wireless sensors) comprising circuits located in the interlaminar region of multi-layer articles. The circuits can be used to detect cracks, holes, and other types of defects in solid bodies with which the circuits are associated, in some cases. In some embodiments, the capacitor(s) of the circuits can be arranged such that they substantially surround other circuit elements, ensuring that determination of cracks, holes, and other defects can be achieved prior to failure of the circuit. The subject matter of the present disclosure involves, in some cases, interrelated products, alternative solutions to a particular problem, and/or a plurality of different uses of one or more systems and/or articles.

In certain embodiments, an article is described. In some embodiments, the article comprises a solid body; and a circuit associated with the solid body, the circuit comprising: an inductor; and a capacitor electronically coupled to and substantially surrounding the inductor.

According to some embodiments, the article comprises: a solid body; a first circuit associated with the solid body, the first circuit comprising an inductor and a capacitor electronically coupled to the inductor; and a second circuit associated with the solid body, the second circuit comprising an inductor and a capacitor electronically coupled to the inductor; wherein the capacitor of the first circuit substantially surrounds the inductor of the second circuit and the capacitor of the second circuit.

According to certain embodiments, the article comprises: a solid body comprising a first layer and a second layer, the first layer and the second layer defining an interface; and a circuit located at the interface between the first layer and the second layer, the circuit comprising an inductor; and a parallel-plate capacitor comprising a first electrode, a second electrode, and a non-conductive material between the first electrode and the second electrode, wherein the parallel-plate capacitor is electronically coupled to the inductor.

In some embodiments, the article comprises: a solid body comprising a first layer and a second layer, the first layer and the second layer defining an interface; a first circuit located at the interface between the first layer and the second layer; and a second circuit located at the interface between the first layer and the second layer. In certain embodiments, the first circuit comprises an inductor and a parallel-plate capacitor coupled to the inductor, the parallel-plate capacitor comprising a first electrode, a second electrode, and a non-conductive material between the first electrode and the second electrode, wherein a surface of the first electrode that faces the second electrode is substantially parallel to the interface between the first layer and the second layer, and a surface of the second electrode that faces the first electrode is substantially parallel to the interface between the first layer and the second layer. According to some embodiments, the second circuit comprises an inductor and a parallel-plate capacitor coupled to the inductor, the parallel-plate capacitor comprising a first electrode, a second electrode, and a non-conductive material between the first electrode and the second electrode, wherein a surface of the first electrode that faces the second electrode is substantially parallel to the interface between the first layer and the second layer, and a surface of the second electrode that faces the first electrode is substantially parallel to the interface between the first layer and the second layer. According to certain embodiments, the first electrode of the parallel plate capacitor of the first circuit and the second electrode of the parallel plate capacitor of the first circuit each substantially surround the inductor, the first electrode, and the second electrode of the second circuit.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure.

FIG. 1A is a top-view schematic illustration of a circuit comprising a capacitor and an inductor, in which the capacitor surrounds the inductor, in accordance with certain embodiments.

FIG. 1B is a cross-sectional schematic illustration of the circuit of FIG. 1A, taken along Section A-A of FIG. 1A.

FIG. 1C is, according to certain embodiments, a top-view schematic illustration of a circuit in which the capacitor does not completely surround (but does still substantially surround) the inductor.

FIG. 1D is a top-view schematic illustration of the two-dimensional convex hull of the capacitor as it is illustrated in FIG. 1C, in accordance with some embodiments.

FIG. 1E is, according to certain embodiments, a top-view schematic illustration of a circuit in which the capacitor does not substantially surround the inductor.

FIG. 1F is a top-view schematic illustration of the two-dimensional convex hull of the capacitor as it is illustrated in FIG. 1E, in accordance with some embodiments.

FIG. 1G is a circuit diagram of the circuit shown in FIGS. 1A-1B.

FIG. 1H is a cross-sectional schematic illustration of the circuit of FIG. 1A, taken along Section A-A of FIG. 1A, and in which the circuit is positioned between first and second layers of a multi-layer material.

FIG. 2A is a top-view schematic illustration of a circuit comprising a capacitor and an inductor, in accordance with certain embodiments.

FIG. 2B is a cross-sectional schematic illustration of the circuit of FIG. 2A, taken along Section A1-A1 of FIG. 2A.

FIG. 2C is a cross-sectional schematic illustration of the circuit of FIG. 2A, taken along Section A1-A1 of FIG. 2A, and in which the circuit is positioned between first and second layers of a multi-layer material.

FIG. 3A is a top-view schematic illustration of an alternative embodiment of a circuit comprising a capacitor and an inductor, in accordance with certain embodiments.

FIG. 3B is a cross-sectional schematic illustration of the circuit of FIG. 3A, taken along Section A2-A2 of FIG. 3A.

FIG. 3C is a cross-sectional schematic illustration of the circuit of FIG. 3A, taken along Section A2-A2 of FIG. 3A, and in which the circuit is positioned between first and second layers of a multi-layer material.

FIG. 4A is a top-view schematic illustration of an article comprising a first circuit comprising an inductor and a capacitor and a second circuit comprising an inductor and a capacitor, in which the inductor and the capacitor of the first circuit both surround the inductor and the capacitor of the second circuit, in accordance with some embodiments.

FIG. 4B is a cross-sectional schematic illustration of the circuits in FIG. 4A, taken along Section B-B of FIG. 4A.

FIG. 4C is a cross-sectional schematic illustration of the circuits of FIG. 4A, taken along Section B-B of FIG. 4A, and in which the circuits are positioned between first and second layers of a multi-layer material.

FIG. 5A is a top-view schematic illustration of an alternative embodiment of an article comprising a first circuit comprising an inductor and a capacitor and a second circuit comprising an inductor and a capacitor, in which the inductor and the capacitor of the first circuit both surround the inductor and the capacitor of the second circuit.

FIG. 5B is a cross-sectional schematic illustration of the circuits in FIG. 5A, taken along Section B1-B1 of FIG. 5A.

FIG. 5C is a cross-sectional schematic illustration of the circuits of FIG. 5A, taken along Section B1-B1 of FIG. 5A, and in which the circuits are positioned between first and second layers of a multi-layer material.

FIG. 5D is a top-view schematic illustration of an article comprising a first circuit comprising an inductor and a capacitor and a second circuit comprising an inductor and an interdigitated capacitor, in which the inductor and the capacitor of the first circuit both surround the inductor and the interdigitated capacitor of the second circuit, in accordance with certain embodiments.

FIG. 6A is a top-view schematic illustration of yet another alternative embodiment of an article comprising a first circuit comprising an inductor and a capacitor and a second circuit comprising an inductor and a capacitor, in which the inductor and the capacitor of the first circuit both surround the inductor and the capacitor of the second circuit.

FIG. 6B is a cross-sectional schematic illustration of the circuits in FIG. 6A, taken along Section B2-B2 of FIG. 6A.

FIG. 6C is a cross-sectional schematic illustration of the circuits of FIG. 6A, taken along Section B2-B2 of FIG. 6A, and in which the circuits are positioned between first and second layers of a multi-layer material.

FIG. 7A is a top-view schematic illustration of an article comprising a first circuit comprising an inductor and a capacitor and a second circuit comprising an inductor and a capacitor, in which the capacitor of the first circuit surrounds the inductor of the first circuit and the inductor and the capacitor of the second circuit, in accordance with some embodiments.

FIG. 7B is a cross-sectional schematic illustration of the circuits in FIG. 7A, taken along Section B3-B3 of FIG. 7A.

FIG. 7C is a cross-sectional schematic illustration of the circuits of FIG. 7A, taken along Section B3-B3 of FIG. 7A, and in which the circuits are positioned between first and second layers of a multi-layer material.

FIG. 8A is a top-view schematic illustration of an alternative embodiment of an article comprising a first circuit comprising an inductor and a capacitor and a second circuit comprising an inductor and a capacitor, in which the capacitor of the first circuit surrounds the inductor of the first circuit and the inductor and the capacitor of the second circuit.

FIG. 8B is a cross-sectional schematic illustration of the circuits in FIG. 8A, taken along Section B4-B4 of FIG. 8A.

FIG. 8C is a cross-sectional schematic illustration of the circuits of FIG. 8A, taken along Section B4-B4 of FIG. 8A, and in which the circuits are positioned between first and second layers of a multi-layer material.

FIG. 9A is a top-view schematic illustration of yet another alternative embodiment of an article comprising a first circuit comprising an inductor and a capacitor and a second circuit comprising an inductor and a capacitor, in which the capacitor of the first circuit surrounds the inductor of the first circuit and the inductor and the capacitor of the second circuit.

FIG. 9B is a cross-sectional schematic illustration of the circuits in FIG. 9A, taken along Section B5-B5 of FIG. 9A.

FIG. 9C is a cross-sectional schematic illustration of the circuits of FIG. 9A, taken along Section B5-B5 of FIG. 9A, and in which the circuits are positioned between first and second layers of a multi-layer material.

FIG. 10A is a top-view schematic illustration of an article comprising a first circuit comprising an inductor and a capacitor and a second circuit comprising an inductor and a capacitor.

FIG. 10B is a cross-sectional schematic illustration of the circuits in FIG. 10A, taken along Section B6-B6 of FIG. 10A.

FIG. 10C is a cross-sectional schematic illustration of the circuits of FIG. 10A, taken along Section B6-B6 of FIG. 10A, and in which the circuits are positioned between first and second layers of a multi-layer material.

FIG. 11A is a top-view schematic illustration of an article comprising a first circuit comprising an inductor and a capacitor and a second circuit comprising an inductor and a capacitor, in which the inductors of the first and second circuits are both surrounded by the capacitor of the first circuit and the capacitor of the second circuit.

FIG. 11B is a cross-sectional schematic illustration of the article of FIGS. 11A and 11C, taken along Section C-C of FIGS. 11A and 11C.

FIG. 11C is a bottom-view schematic illustration of the circuit arrangement shown in FIG. 11A.

FIG. 12 is a circuit diagram of the circuit arrangements shown in FIGS. 4A-4B, 5A-5B, 7A-7B, 8A-8B, and 10A-10B.

FIGS. 13A-13D are a series of cross-sectional schematic illustrations showing the fabrication of a capacitor in which electronically conductive nanostructures are used to form the electrodes, in accordance with certain embodiments.

FIG. 14 is a schematic illustration of the fabrication of an inductor in which electronically conductive nanostructures are used to form the electronically conductive pathway of the inductor, in accordance with certain embodiments.

FIG. 15 is a cross-sectional schematic illustration showing elongated nanostructures mechanically reinforcing an interface between a circuit element and an adjacent layer, in accordance with certain embodiments.

FIG. 16 is a schematic illustration showing the measurement of a resonant frequency of a sensor, in accordance with some embodiments.

FIG. 17A shows a top-view schematic illustration of a sensor for wired detection of crack propagation (left) and a cross-sectional schematic illustration of the sensor for wired detection of crack propagation (right), in accordance with some embodiments.

FIG. 17B is, according to some embodiments, an embodiment of a sensor for wired detection of crack propagation.

FIG. 18A shows, according to some embodiments, the change in capacitance as a function of crack length in millimeters for a first sample as measured by a wired sensor.

FIG. 18B shows, according to some embodiments, the change in frequency as a function of crack length in millimeters as determined from the change in capacitance measured in FIG. 18A.

FIG. 19A shows, according to some embodiments, the change in capacitance as a function of crack length in millimeters for a second sample as measured by a wired sensor.

FIG. 19B shows, according to some embodiments, the change in frequency as a function of crack length in millimeters as determined from the change in capacitance measured in FIG. 19A.

FIG. 20A is a cross-sectional schematic illustration of a sensor for wireless detection of crack propagation, in accordance with some embodiments.

FIG. 20B is, according to some embodiments, an embodiment of a sensor for wireless detection of crack propagation.

FIG. 21A shows, according to some embodiments, a reader wireless excitation signal and a sum of a reader echo signal and a sensor echo signal prior to crack propagation.

FIG. 21B shows, according to some embodiments, a reader wireless excitation signal and a sum of a reader echo signal and a sensor echo signal after crack propagation.

FIG. 22A shows, according to some embodiments, the change in capacitance as a function of crack length in millimeters as measured by a wireless sensor.

FIG. 22B shows, according to some embodiments, the change in frequency as a function of crack length in millimeters as measured by a wireless sensor.

### DETAILED DESCRIPTION

Sensors (e.g., wireless sensors), and related systems and methods, are generally described. Certain aspects are related to architectures that can be integrated into the interlaminar region of composites (e.g., advanced composites) and other layered materials. In accordance with certain embodiments, the sensors comprise an inductor and a capacitor that is electronically coupled to the inductor (e.g., as part of an RLC circuit). In some embodiments, a sensor is provided in which the capacitor substantially surrounds the inductor. In other embodiments, the capacitor is positioned alongside (e.g., adjacent to) the inductor. The capacitor may, in some embodiments, be a parallel-plate capacitor comprising a first electrode, a second electrode, and a non-conductive material between the first electrode and the second electrode. Arranging the capacitor and the inductor such that the capacitor substantially surrounds (or completely surrounds) the inductor and/or such that the capacitor is positioned alongside the inductor can help ensure that, as cracks and/or other defects (e.g., holes or other structural defects) propagate through the structure, the sensor maintains its ability to function. For example, in accordance with certain embodiments, arranging the capacitor and the inductor such that the capacitor substantially surrounds (or completely surrounds) the inductor and/or such that the capacitor is positioned alongside the inductor can help ensure that, as cracks and/or other defects (e.g., holes or other structural defects) propagate through the structure, the structure is able to detect the crack, hole, and/or other structural defect while maintaining its ability to function.

Certain embodiments are related to articles comprising multiple circuits, each comprising an inductor and a capacitor electronically coupled to the inductor. In some embodiments, the capacitor of the first circuit substantially surrounds the capacitor and the inductor of the second circuit. In other embodiments, the first circuit may be positioned adjacent to the second circuit. In some such embodiments, the first circuit may be configured such that capacitor of the first circuit is positioned alongside (e.g., adjacent to) the inductor of the first circuit, and the second circuit may be configured such that the capacitor of the second circuit is positioned alongside (e.g., adjacent to) the inductor of the second circuit. Arranging the circuits such that the capacitor of the first circuit substantially surrounds (or completely surrounds) the capacitor and the inductor of the second circuit and/or such that the first circuit is positioned adjacent to the second circuit can allow one to use the second circuit as a reference circuit, allowing the user to correct for changes to and/or differences in the environment (e.g., related to temperature, humidity, strain, creep, aging, etc.) when taking a measurement from the first circuit.

The sensor architectures can, in some embodiments, provide structural reinforcement between two layers of a composite. In this way, in accordance with certain embodiments, the sensor architectures can perform better than certain other non-invasive sensor solutions because the sensors add mechanical reinforcement.

In some embodiments, the electrically conductive sensor elements (e.g., electrodes of the capacitor(s), the electronic pathway of the inductor, etc.) comprise nanocomposites (e.g., formed by arranging electronically conductive elongated nanostructures within a conductive or non-conductive matrix material).

Certain of the circuit arrangements described herein can be used as wireless interlaminar sensors. For example, the circuits comprising the inductors and capacitors can be used, in some embodiments, as RLC resonators. In some embodiments, one can wirelessly interrogate an RLC resonator to determine whether the resonant frequency has changed, an indication that a crack, hole, or other structural defect has been formed within or near the sensor.

As noted above, certain aspects are related to articles. In some embodiments, the article comprises a solid body and a circuit associated with the solid body. The solid body can be of any of a variety of configurations, such as a bulk article, a multi-layer laminate, or any other solid article. It should be understood that the phrase “solid body” does not mean that the entirety of the body is necessarily solid, and in some cases, voids within the body (which may be occupied, for example, by gas, liquid, vacuum, etc.) can be present.

In some embodiments, the solid body is an article for which one wishes to monitor structural health. Examples include, but are not limited to, a component of a land system and/or vehicle, a water system and/or vehicle, an air system and/or vehicle, and/or a space system and/or vehicle. In some embodiments, the article is part of an airplane, a boat, a motor vehicle (e.g., motorcycle, car, truck, bus), a space vehicle (e.g., a rocket) component of a building (e.g., a beam, a steel component, a concrete component, and the like), and the like.

In certain embodiments, the article comprises a circuit associated with the solid body. The circuit can be associated with the solid body in any of a variety of ways, as described in detail below. In some embodiments, the circuit can be located at the interface of two layers of a multi-layer material. Positioning the sensor in this manner can, in certain embodiments, allow one to detect the presence of and/or change in a crack, hole, or other structural defect between the layers of the multi-layer material. In some embodiments, and as explained in more detail below, one or more components of the circuit can comprise elongated nanostructures that can be used to reinforce an interface between the circuit component and a region of the solid body (e.g., one or more layers of the solid body).

In some embodiments, the circuit comprises an inductor and a capacitor electronically coupled to the inductor. The electronic coupling between the inductor and the capacitor can be achieved, for example, by connecting the inductor and the capacitor using an electronically conductive material (e.g., metal, carbon, or any other suitable electronically conductive material).

In certain embodiments, the inductor and the capacitor can be part of an RLC circuit. The resistor portion of the RLC circuit can be a standalone resistor, or it can correspond to the resistance intrinsically present in the electronically conductive components of the inductor, the capacitor, and/or the electronic couplings between the two. In some embodiments, the RLC circuit can be used as a resonator, which can be wirelessly interrogated to determine a mechanical characteristic of the solid body, as described in more detail below

In some embodiments, and as described in more detail elsewhere herein, the circuit can be an oscillator. The circuit can be wirelessly interrogated, in some embodiments, and a return signal can be generated by the circuit that is detected and analyzed to determine whether a crack, hole, or other structural defect has been introduced into and/or has changed within the solid body with which the circuit is associated.

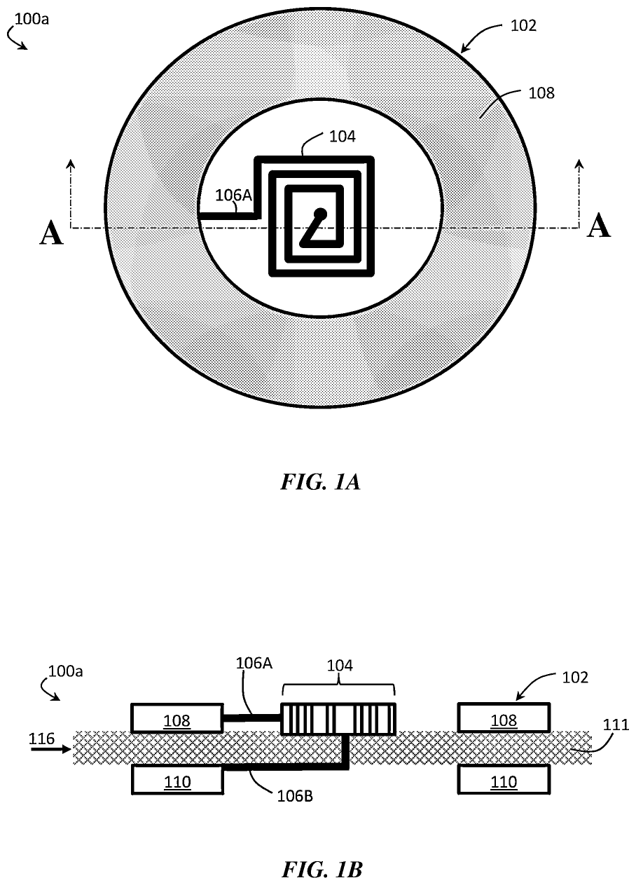

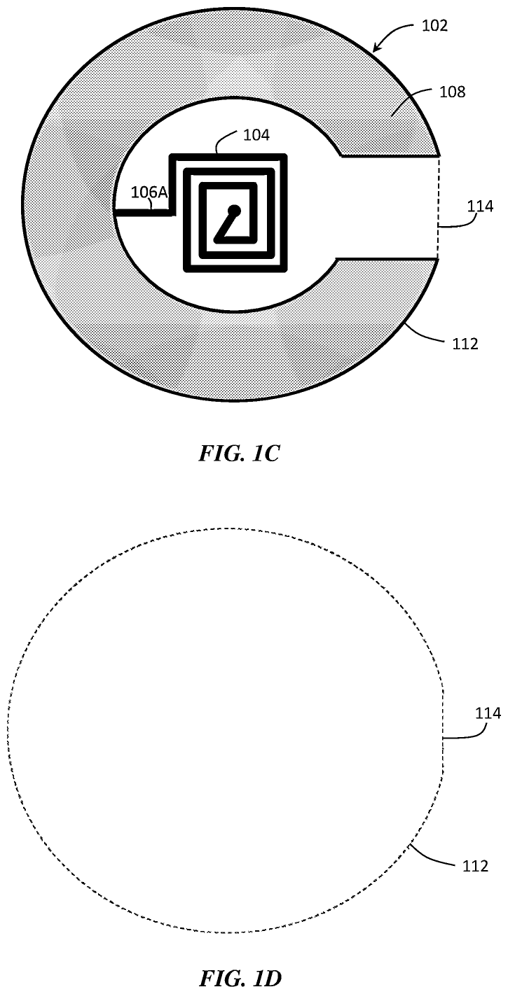

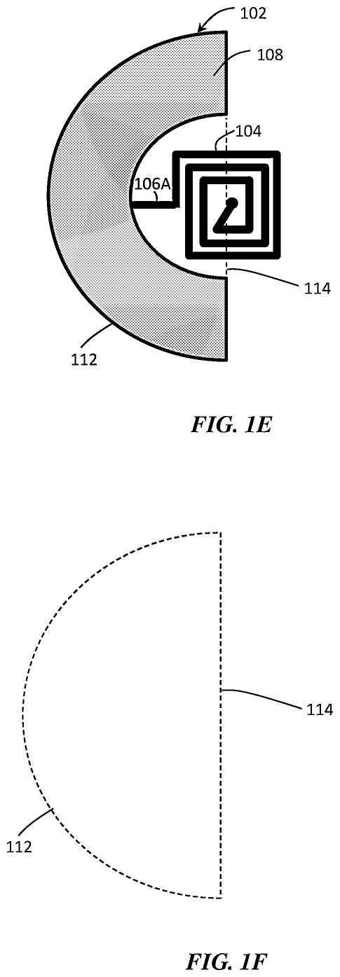

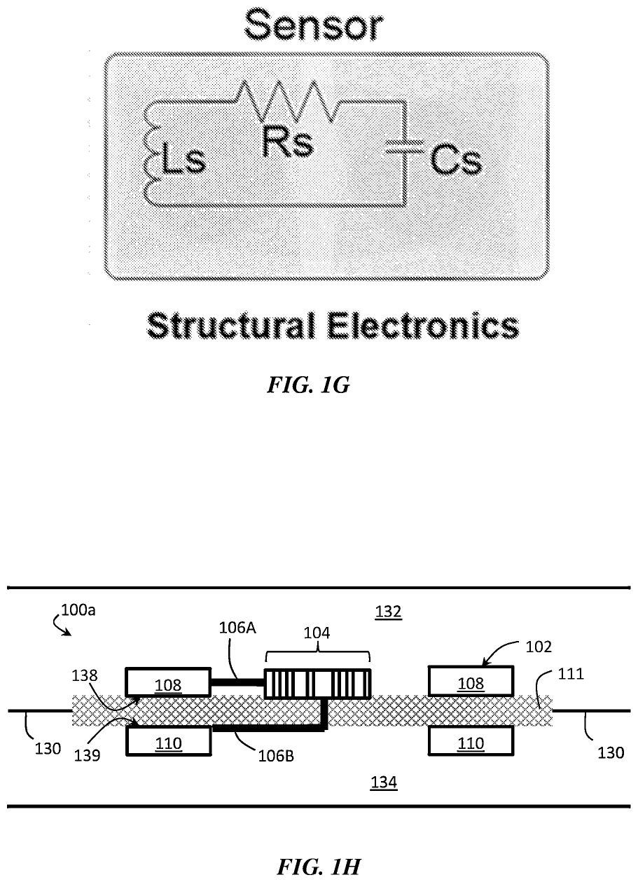

One example of a circuit that can be used in association with certain of the embodiments described herein is shown in FIGS. 1A-1B. FIG. 1A is a top-view schematic illustration of circuit 100a, and FIG. 1B is a cross-sectional schematic illustration of circuit 100a taken along Section A-A of FIG. 1A. In FIGS. 1A-1B, circuit 100a comprises capacitor 102 and inductor 104 electronically coupled to capacitor 102 via electronically conductive pathways 106A and 106B.

As illustrated in FIGS. 1A-1B, capacitor 102 is a parallel-plate capacitor comprising first electrode 108 and second electrode 110 (hidden from view in FIG. 1A by electrode 108). As described in further detail below, in some embodiments, the electrodes of the capacitor can comprise electronically conductive nanostructures (e.g., electronically conductive elongated nanostructures, such as carbon nanotubes) embedded within a non-conductive (e.g., electrically insulating) matrix. The nanostructures within the capacitor can be used, for example, to provide mechanical reinforcement between the capacitor electrode and adjacent structures (e.g., a layer of a multi-layer composite).

In some embodiments, capacitor 102 further comprises non-conductive material 111 between first electrode 108 and second electrode 110. The non-conductive material can be, for example, any of a variety of suitable electrically insulating materials that prevent short circuiting between the capacitor electrodes during operation. Examples of non-conductive materials for use within the capacitor include, but are not limited to, polymers (e.g., epoxy resin (e.g., EPON resin), paramethylstyrene (PMS), para-methoxyamphetamine (PMA), polyimide (e.g., Kapton®), polyether ether ketone (PEEK), polyether ketone ketone (PEKK), bis-maleimide (BMI), cyanate ester, and the like), metal and/or metalloid oxides, glasses, ceramics, or any combinations of two or more of these materials.

Inductor 104 can assume any of a variety of configurations. In the embodiment illustrated in FIG. 1A, inductor 104 comprises an electronically conductive pathway arranged in a spiral shape. Other shapes and/or configurations are also possible.

As described in further detail below, in some embodiments, the inductor can comprise electronically conductive nanostructures (e.g., electronically conductive elongated nanostructures, such as carbon nanotubes) embedded within a non-conductive (e.g., electrically insulating) matrix. The nanostructures within the inductor can be used, for example, to provide mechanical reinforcement between the inductor and adjacent structures (e.g., a layer of a multi-layer composite).

In the embodiment shown in FIGS. 1A-1B, inductor 104 is electronically coupled to capacitor 102 via electronically conductive pathways 106A and 106B. In particular, electronically conductive pathway 106A electronically couples one end of inductor 104 to electrode 108 of capacitor 102, and electronically conductive pathway 106B electronically couples a second end of inductor 104 (illustrated in FIG. 1A as a solid black circle) to electrode 110 of capacitor 102. When connected in this fashion, the capacitor and the inductor can form an RLC circuit, such as the circuit illustrated in FIG. 1G. In some embodiments, a dedicated resistor can be incorporated into the circuit. In other embodiments, the intrinsic electrical resistivity of the circuit elements and/or the electronically conductive pathways coupling the circuit elements to each other can serve as the resistor of the RLC circuit.

In certain embodiments, the capacitor of the circuit substantially surrounds the inductor of the circuit. As used herein, a capacitor (or an electrode thereof) is said to “substantially surround” another component of a circuit (e.g., an inductor) if, when viewed from at least one angle, the two-dimensional convex hull of the capacitor completely surrounds the other component of the circuit. The phrase “two-dimensional convex hull” of a given view of an article is given its ordinary meaning in geometry and refers to the smallest two-dimensional convex set that contains the article. The convex hull is also sometimes referred to in the field of geometry as the two-dimensional convex envelope or the two-dimensional convex closure, and it can be visualized as the shape enclosed by a rubber band stretched around a two-dimensional view of an object. Using FIG. 1A to illustrate, capacitor 102 substantially surrounds inductor 104 because, when viewed from the angle illustrated in FIG. 1A, the outer perimeter of capacitor electrode 108 (which also corresponds to the two-dimensional convex hull of capacitor 102 as shown in FIG. 1A) completely surrounds inductor 104. Another example of a capacitor substantially surrounding an inductor is shown in FIG. 1C. In FIG. 1C, capacitor 102 substantially surrounds inductor 104 because the two-dimensional convex hull of the view of capacitor 102 shown in FIG. 1C (which includes outer boundary 112 of electrode 108 coupled with dotted line 114) completely surrounds inductor 104. FIG. 1D is a schematic illustration of the two-dimensional convex hull of capacitor 102 as shown in FIG. 1C, with all circuit elements removed from the figure for clarity.

FIG. 1E is an illustration of an instance in which capacitor 102 does not substantially surround inductor 104. This is because, in the view shown in FIG. 1E, the two-dimensional convex hull of capacitor 102 (which includes outer boundary 112 of electrode 108 coupled with dotted line 114) does not completely surround inductor 104. For the layout illustrated in FIG. 1E, there are also no other views for which the two-dimensional convex hull of the capacitor would completely surround the inductor. FIG. 1F is a schematic illustration of the two-dimensional convex hull of capacitor 102 as shown in FIG. 1E, with all circuit elements removed from the figure for clarity.

Arranging the capacitor such that it substantially surrounds the inductor can increase the chances that the circuit will remain operational even after a crack, hole, or other structural defect has been introduced to and/or grows within the non-conductive material between the first and second electrodes of the capacitor. Referring to FIG. 1B, for example, if a crack propagates in the direction of arrow 116, the distance between electrodes 108 and 110 of capacitor 102 will increase before inductor 104 or electronic pathways 106A or 106B are disrupted. This will allow the user to obtain a signal from circuit 100a after the structural defect has been introduced into the article and before the circuit becomes non-functional. If, on the other hand, inductor 104 were located outside the capacitor, it is much more likely that the crack or other structural defect would destroy the functionality of the circuit (e.g., by disconnecting one portion of the inductor from another portion of the inductor) before the structural defect can be detected.

In some embodiments, the capacitor and the inductor can be arranged such that, when viewed from at least one angle (e.g., an angle from which the capacitor and/or an electrode thereof substantially surrounds the inductor), a relatively large percentage of the length of the two-dimensional convex hull of the capacitor has a portion of the capacitor positioned between it and the geometric center of the inductor. Using FIG. 1C to illustrate, portion 114 of the two-dimensional convex hull of capacitor 102 does not have any part of the capacitor positioned between it and the geometric center of inductor 104, and portion 112 of the two-dimensional convex hull of capacitor 102 does have portions of the capacitor positioned between it and the geometric center of inductor 104. Assuming, in FIG. 1C, that the length of line 114 is around 1 unit and the length of the remaining portion of the two-dimensional convex hull is about 14 units, then the percentage of the convex hull that has capacitor portions positioned between it and the geometric center of the inductor would be about 93.3%. Generally, it is desirable to have as much of the inductor surrounded by the capacitor as possible, but it might occasionally be necessary to introduce breaks in the capacitor structure to allow for electrical leads and other components.

In some embodiments, the capacitor and the inductor are arranged such that, when viewed from at least one angle (e.g., an angle that is perpendicular to a capacitive surface of the capacitor, an angle that is perpendicular to an interface between two layers within which the circuit is positioned), at least 50%, at least 75%, at least 85%, at least 90%, at least 95%, at least 98%, at least 99%, or all of the length of the two-dimensional convex hull of the capacitor has a portion of the capacitor positioned between it and the geometric center of the inductor. In some embodiments, the capacitor substantially surrounds (or completely surrounds) the inductor when viewed from this angle.

In instances in which, for at least one view, the two-dimensional convex hull of the capacitor completely surrounds the inductor and the entire length of the two-dimensional convex hull of the capacitor has a portion of the capacitor positioned between it and the geometric center of the inductor, the capacitor is said to completely surround the inductor. One example of such an arrangement is illustrated in FIG. 1A, in which capacitor 102 completely surrounds inductor 104.

In some embodiments, the first electrode of the capacitor substantially surrounds (or completely surrounds) the inductor of the circuit. In certain such embodiments, the capacitor and the inductor are arranged such that, when viewed from at least one angle, at least 50%, at least 75%, at least 85%, at least 90%, at least 95%, at least 98%, at least 99%, or all of the length of the two-dimensional convex hull of the first electrode of the capacitor has a portion of the first electrode positioned between it and the geometric center of the inductor. In some embodiments, the first electrode of the capacitor substantially (or completely) surrounds the inductor when viewed from this angle.

In some embodiments, the second electrode of the capacitor substantially surrounds (or completely surrounds) the inductor of the circuit. In certain such embodiments, the capacitor and the inductor are arranged such that, when viewed from at least one angle, at least 50%, at least 75%, at least 85%, at least 90%, at least 95%, at least 98%, at least 99%, or all of the length of the two-dimensional convex hull of the second electrode of the capacitor has a portion of the second electrode positioned between it and the geometric center of the inductor. In some embodiments, the second electrode of the capacitor substantially (or completely) surrounds the inductor when viewed from this angle.

In some embodiments, when viewed from at least one angle that is perpendicular to a surface of a capacitor electrode that faces a capacitor counter-electrode, the two-dimensional convex hull of the capacitor completely surrounds the inductor. In some embodiments, the capacitor and the inductor are arranged such that, when viewed from at least one angle that is perpendicular to a surface of a capacitor electrode that faces a capacitor counter-electrode, at least 50%, at least 75%, at least 85%, at least 90%, at least 95%, at least 98%, at least 99%, or all of the length of the two-dimensional convex hull of the first electrode of the capacitor has a portion of the first electrode positioned between it and the geometric center of the inductor. In some embodiments, the first electrode of the capacitor substantially (or completely) surrounds the inductor when viewed from this angle.

In certain embodiments, the capacitor and the inductor are arranged such that, when viewed from at least one angle that is perpendicular to a surface of a capacitor electrode that faces a capacitor counter-electrode, at least 50%, at least 75%, at least 85%, at least 90%, at least 95%, at least 98%, at least 99%, or all of the length of the two-dimensional convex hull of the second electrode of the capacitor has a portion of the second electrode positioned between it and the geometric center of the inductor. In some embodiments, the second electrode of the capacitor substantially (or completely) surrounds the inductor when viewed from this angle.

In some embodiments, when viewed from at least one angle that is perpendicular to an interfacial surface of a multi-layer article within which the circuit is located, the two-dimensional convex hull of the capacitor completely surrounds the inductor. In some embodiments, the capacitor and the inductor are arranged such that, when viewed from at least one angle that is perpendicular to an interfacial surface of a multi-layer article within which the circuit is located, at least 50%, at least 75%, at least 85%, at least 90%, at least 95%, at least 98%, at least 99%, or all of the length of the two-dimensional convex hull of the first electrode of the capacitor has a portion of the first electrode positioned between it and the geometric center of the inductor. In some embodiments, the first electrode of the capacitor substantially (or completely) surrounds the inductor when viewed from this angle.

In certain embodiments, the capacitor and the inductor are arranged such that, when viewed from at least one angle that is perpendicular to an interfacial surface of a multi-layer article within which the circuit is located, at least 50%, at least 75%, at least 85%, at least 90%, at least 95%, at least 98%, at least 99%, or all of the length of the two-dimensional convex hull of the second electrode of the capacitor has a portion of the second electrode positioned between it and the geometric center of the inductor. In some embodiments, the second electrode of the capacitor substantially (or completely) surrounds the inductor when viewed from this angle.

As noted above, the sensors described herein can be associated with a solid body in any of a variety of suitable ways. In some embodiments, the circuit is part of a structure laminated to an external surface of the solid body.

In certain embodiments, the circuit is located in an interlaminar region of a multi-layer article. For example, in some embodiments, the solid body with which the sensor is associated comprises a first layer and a second layer, where the first layer and the second layer define an interface. In some such embodiments, the circuit is located at the interface between the first layer and the second layer. One example of this is illustrated in FIG. 1H. In FIG. 1H, circuit 100a from FIGS. 1A-1B has been arranged at interface 130 between first layer 132 and second layer 134.

The first layer and/or the second layer of the multi-layer article can comprise any of a variety of materials. In some embodiments, the first layer and/or the second layer comprises a polymer (e.g., epoxy resin (e.g., EPON resin), paramethylstyrene (PMS), para-methoxyamphetamine (PMA), polyimide (e.g., Kapton®), polyether ether ketone (PEEK), polyether ketone ketone (PEKK), bis-maleimide (BMI), cyanate ester, and the like). In certain embodiments, the first layer and/or the second layer comprise a prepreg. As used herein, the term “prepreg” refers to one or more layers of thermoset or thermoplastic resin containing embedded fibers, for example fibers of carbon, glass, silicon carbide, and the like. In some embodiments, the thermoset material includes epoxy, rubber strengthened epoxy, BMI, PMK-15, polyesters, and/or vinylesters. In certain embodiments, the thermoplastic material includes polyamides, polyimides, polyarylene sulfide, polyetherimide, polyesterimides, polyarylenes, polysulfones, polyethersulfones, polyphenylene sulfide, polyetherimide, polypropylene, polyolefins, polyketones, polyetherketones, polyetherketoneketone, polyetheretherketones, and/or polyester. According to certain embodiments, the prepreg includes fibers that are aligned and/or interlaced (woven or braided). In some embodiments, the prepregs are arranged such the fibers of many layers are not aligned with fibers of other layers, the arrangement being dictated by directional stiffness requirements of the article to be formed. In certain embodiments, the fibers cannot be stretched appreciably longitudinally, and thus, each layer cannot be stretched appreciably in the direction along which its fibers are arranged. Exemplary prepregs include thin-ply prepregs, non-crimp fabric prepregs, TORLON thermoplastic laminate, PEEK (polyether ether ketone, Imperial Chemical Industries, PLC, England), PEKK (polyether ketone ketone, DuPont) thermoplastic, T800H/3900 2 thermoset from Toray (Japan), and AS4/3501 6 thermoset from Hercules (Magna, Utah), IMA from Hexcel (Magna, Utah), IM7/M21 from Hexcel (Magna, Utah), IM7/977-3 from Hexcel (Magna, Utah), Cycom 5320-1 from Cytec (Woodland Park. New Jersey), and AS4/3501 6 thermoset from Hexcel (Magna, Utah).

In some embodiments, a surface of the first electrode of the capacitor of the circuit that faces the second electrode of the capacitor of the circuit is substantially parallel to the interface between the first layer and the second layer. For example, in FIG. 1H, surface 138 of first electrode 108 (which faces second electrode 110) is substantially parallel to interface 130. In some embodiments, a surface of the second electrode of the capacitor of the circuit that faces the first electrode of the capacitor of the circuit is substantially parallel to the interface between the first layer and the second layer. For example, in FIG. 1H, surface 139 of second electrode 110 (which faces first electrode 108) is substantially parallel to interface 130. Two objects are generally said to be substantially parallel to each other when they are parallel to within 10° (and, in some embodiments, to within 5°, within 2°, or within 1°).

In certain embodiments, the circuit can be configured such that cracks, holes, or other structural defects propagating in the interlaminar region of the multi-layer article are more likely to propagate through the region of non-conductive material of the capacitor of the circuit than through other circuit components. This can be achieved, for example, by aligning the region of the non-conductive material with the interface of the layers. In FIG. 1H, for example, non-conductive material 111 is in the form of a layer that is in contact with and substantially parallel to interface 130 between first layer 132 and second layer 134. In the embodiment shown in FIG. 1H, as a crack, hole, or other structural defect propagates through interface 130, it will come into contact with non-conductive material 111, and further crack, hole, or other structural defect propagation between first electrode 108 and second electrode 110 will be energetically favored relative to crack, hole, or other structural defect propagation elsewhere in the composite.

According to some embodiments, circuit 100a may comprise a structural defect (e.g., a crack) in non-conductive material 111 that has propagated through interface 130. In some such embodiments, the distance between electrodes 108 and 110 of capacitor 102 may be increased relative to the distance between electrodes 108 and 110 of capacitor 102 without a structural defect, and a user may obtain a signal from circuit 100a before the circuit becomes non-functional.

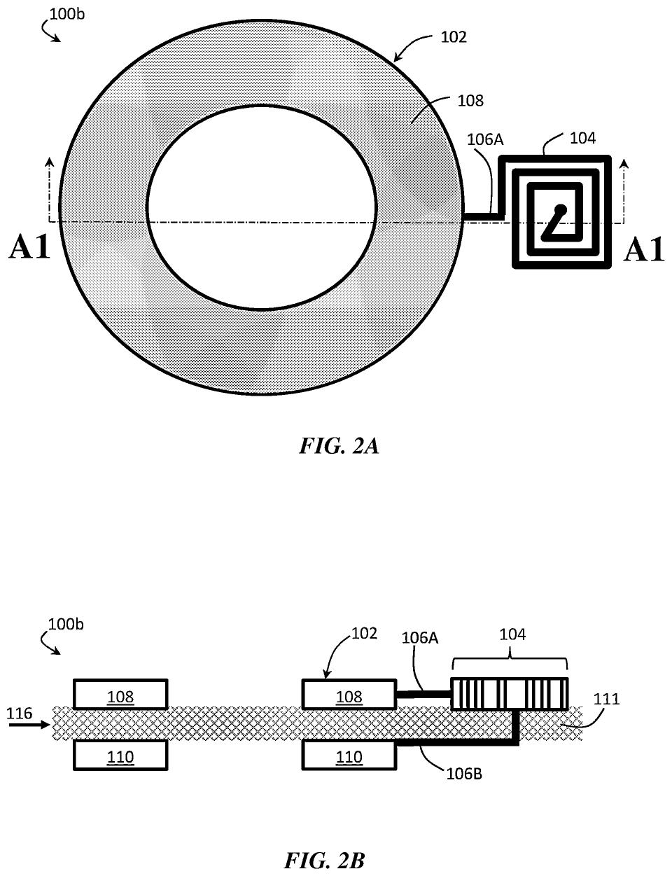

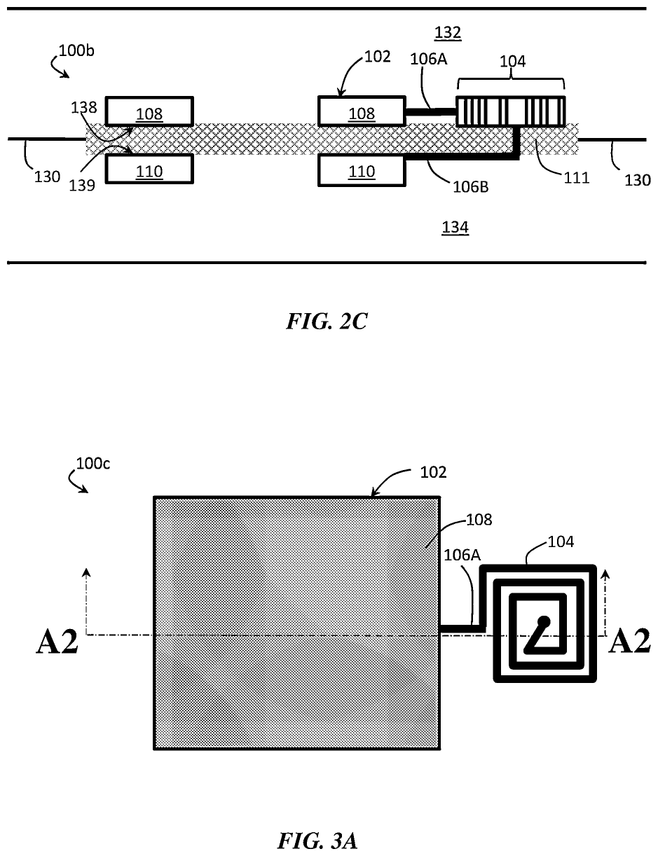

According to certain embodiments, the capacitor and the inductor may be arranged such that the capacitor is positioned alongside (e.g., adjacent to) the inductor. One example of such a circuit that can be used in association with certain of the embodiments described herein is shown in FIGS. 2A-2B. FIG. 2A is a top-view schematic illustration of circuit 100b, and FIG. 2B is a cross-sectional schematic illustration circuit 100b taken along Section A1-A1 of FIG. 2A. In FIGS. 2A-2B, circuit 100b comprises capacitor 102 and inductor 104 electronically coupled to capacitor 102 via electronically conductive pathways 106A and 106B.

As illustrated in FIGS. 2A-2B, capacitor 102 is a parallel-plate capacitor comprising first electrode 108 and second electrode 110 (hidden from view in FIG. 2A by electrode 108). As described elsewhere herein, the electrodes of the capacitor may, in some embodiments, comprise electronically conductive nanostructures (e.g., electronically conductive elongated nanostructures, such as carbon nanotubes) embedded within a non-conductive (e.g., electrically insulating) matrix. The nanostructures within the capacitor can be used, for example, to provide mechanical reinforcement between the capacitor electrode and adjacent structures (e.g., a layer of a multi-layer composite).

In some embodiments, capacitor 102 further comprises non-conductive material 111 between first electrode 108 and second electrode 110. The non-conductive material can be, for example, any of a variety of suitable electrically insulating materials, including those described elsewhere herein.

In the embodiment illustrated in FIG. 2A, inductor 104 comprises an electronically conductive pathway arranged in a spiral shape, although other shapes and/or configurations are also possible. As described elsewhere herein, in some embodiments, the inductor can comprise electronically conductive nanostructures embedded within a non-conductive matrix. The nanostructures within the inductor can be used, for example, to provide mechanical reinforcement between the inductor and adjacent structures (e.g., a layer of a multi-layer composite).

In the embodiment shown in FIGS. 2A-2B, inductor 104 is electronically coupled to capacitor 102 via electronically conductive pathways 106A and 106B. In particular, electronically conductive pathway 106A electronically couples one end of inductor 104 to electrode 108 of capacitor 102, and electronically conductive pathway 106B electronically couples a second end of inductor 104 (illustrated in FIG. 2A as a solid black circle) to electrode 110 of capacitor 102. When connected in this fashion, the capacitor and the inductor can form an RLC circuit, such as the circuit illustrated in FIG. 1G. In some embodiments, a dedicated resistor can be incorporated into the circuit. In other embodiments, the intrinsic electrical resistivity of the circuit elements and/or the electronically conductive pathways coupling the circuit elements to each other can serve as the resistor of the RLC circuit.

As shown in FIGS. 2A-2B, capacitor 102 and inductor 104 may be arranged such that capacitor 102 is positioned alongside (e.g., adjacent to) inductor 104. Arranging the capacitor such that it is positioned alongside (e.g., adjacent to) the inductor can increase the chances that the circuit will remain operational even after a crack, hole, or other structural defect has been introduced to and/or grows within the non-conductive material between the first and second electrodes of the capacitor. Referring to FIG. 2B, for example, if a crack propagates in the direction of arrow 116, the distance between electrodes 108 and 110 of capacitor 102 will increase before inductor 104 or electronic pathways 106A or 106B are disrupted. This will allow the user to obtain a signal from circuit 100b after the structural defect has been introduced into the article and before the circuit becomes non-functional.

According to some embodiments, circuit 100b shown in FIGS. 2A-2B may be located in an interlaminar region of a multi-layer article. For example, in some embodiments, circuit 100b may be located at an interface between a first layer and a second layer of a solid body. One example of this is illustrated in FIG. 2C. In FIG. 2C, circuit 100b from FIGS. 2A-2B has been arranged at interface 130 between first layer 132 and second layer 134 of a solid body. The first layer and/or the second layer of the multi-layer article may comprise any of a variety of materials described elsewhere herein.

In some embodiments, and as shown in FIG. 2C, surface 138 of first electrode 108 (which faces second electrode 110) is substantially parallel to interface 130. According to certain embodiments, and as shown in FIG. 2C, surface 139 of second electrode 110 (which faces first electrode 108) is substantially parallel to interface 130.

In certain embodiments, the circuit can be configured such that cracks, holes, or other structural defects propagating in the interlaminar region of the multi-layer article are more likely to propagate through the region of non-conductive material of the capacitor of the circuit than through other circuit components. This can be achieved, for example, by aligning the region of the non-conductive material with the interface of the layers. In FIG. 2C, for example, non-conductive material 111 is in the form of a layer that is in contact with and substantially parallel to interface 130 between first layer 132 and second layer 134. In the embodiment shown in FIG. 2C, as a crack, hole, or other structural defect propagates through interface 130, it will come into contact with non-conductive material 111, and further crack, hole, or other structural defect propagation between first electrode 108 and second electrode 110 will be energetically favored relative to crack, hole, or other structural defect propagation elsewhere in the composite.

According to some embodiments, circuit 100b may comprise a structural defect (e.g., a crack) in non-conductive material 111 that has propagated through interface 130. In some such embodiments, the distance between electrodes 108 and 110 of capacitor 102 may be increased relative to the distance between electrodes 108 and 110 of capacitor 102 without a structural defect, and a user may obtain a signal from circuit 100a before the circuit becomes non-functional.

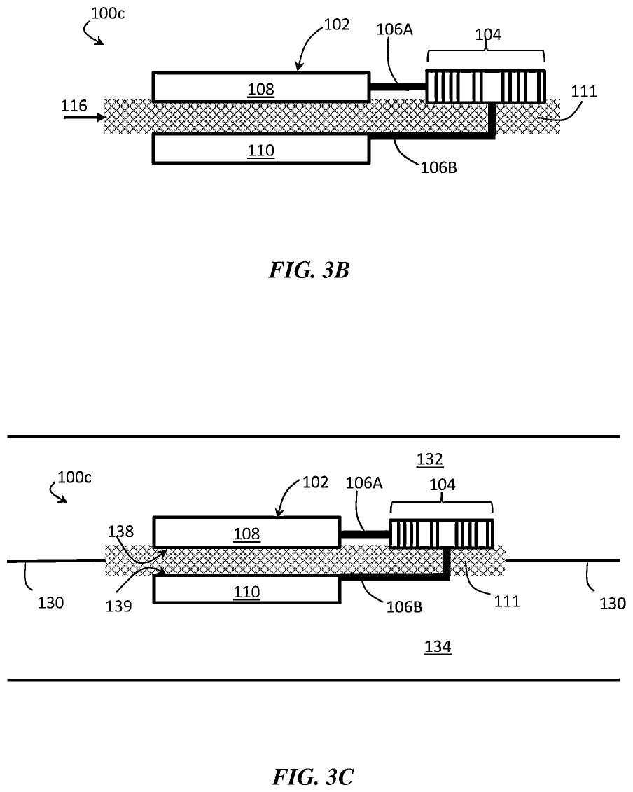

Although the capacitors in FIGS. 1A and 2A are shown as capacitors having a circular shape, the capacitors described herein may have any of a variety of suitable shapes. In certain embodiments, for example, the capacitor has a square shape (e.g., a parallel plate capacitor having a square shape). One example of such a circuit comprising a capacitor having a square shape that can be used in association with certain of the embodiments described herein is shown in FIGS. 3A-3B. FIG. 3A is a top-view schematic illustration of circuit 100c, and FIG. 3B is a cross-sectional schematic illustration of circuit 100c taken along Section A2-A2 of FIG. 3A. As shown in FIGS. 3A-3B, circuit 100c, in some embodiments, comprises capacitor 102 having a square shape. According to some embodiments, the use of a capacitor having a square shape may be advantageous in detecting the propagation of a structural defect (e.g., a crack) if the location of the structural defect is known (e.g., a hot spot). Circuit 100c, in certain embodiments, otherwise functions the same as circuit 100b shown in and described in relation to FIGS. 2A-2B. Other shapes and configurations for circuit are also possible, including, but not limited to, circuits having a triangular, rectangular, and/or oval shape. According to some embodiments, circuit 100c shown in FIGS. 3A-3B may be located in an interlaminar region of a multi-layer article. For example, in some embodiments, circuit 100c may be located at an interface between a first layer and a second layer of a solid body. One example of this is illustrated in FIG. 3C. In some embodiments, circuit 100c located at an interface between a first layer and a second layer of a solid body may function the same as circuit 100b shown in and described in relation to FIG. 2C.

In some embodiments, nanostructures can be incorporated into one or more elements of the circuit (e.g., into a capacitor and/or an inductor). In some embodiments, the nanostructures can serve an electronic function of the circuit components. For example, in some embodiments, the nanostructures are electronically conductive and can be embedded in a non-conductive matrix to impart electronic conductivity to the circuit element. The nanostructures can also be used, in some embodiments, to mechanically reinforce one or more interfaces between a circuit element and an adjacent layer of the multi-layer laminate. Mechanically reinforcing the interface between the capacitor electrode(s) and the adjacent layer(s) and/or between the inductor and the adjacent layer can further increase the odds that cracks, holes, or other structural defects will propagate through the non-conductive region of the capacitor (as opposed to other parts of the circuit and/or the multi-layer material).

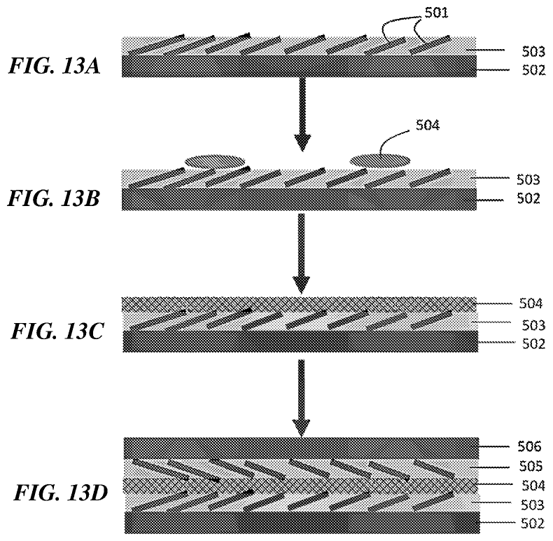

FIGS. 13A-13D are a series of cross-sectional schematic illustrations showing the fabrication of a capacitor in which electronically conductive nanostructures are used to form the electrodes, in accordance with certain embodiments. In FIG. 13A, a collection of elongated nanostructures 501 has been formed on substrate 502 (e.g., a Kapton substrate), for example, using catalytic growth of carbon nanotubes. The collection of elongated nanostructures has been infused with a non-conductive material 503 (e.g., EPON). The elongated nanostructures can provide electrical conductivity, such that the combination of the elongated nanostructures 501 and material 503 forms the first electrode of the capacitor. In FIG. 13B, additional non-conductive material 504 (e.g., EPON) has been placed over elongated nanostructures 501 and non-conductive material 503. In FIG. 13C, non-conductive material 504 has been reformed in the shape of layer. In one non-limiting embodiment, non-conductive material 504 is a layer of Kapton film with epoxy (e.g., having a thickness of less than 50 micrometers, or less than 10 micrometers). In FIG. 13D, a second electrode 505 comprising electronically conductive elongated nanostructures embedded in a non-conductive material layer has been added to the top of the stack from FIG. 13C. Additional substrate 506 may also be included. Optionally, the stack may be cured, for example, using a hot press, to form the final capacitor. Optionally, substrate 502 and/or substrate 506 may be omitted or removed from the capacitor.

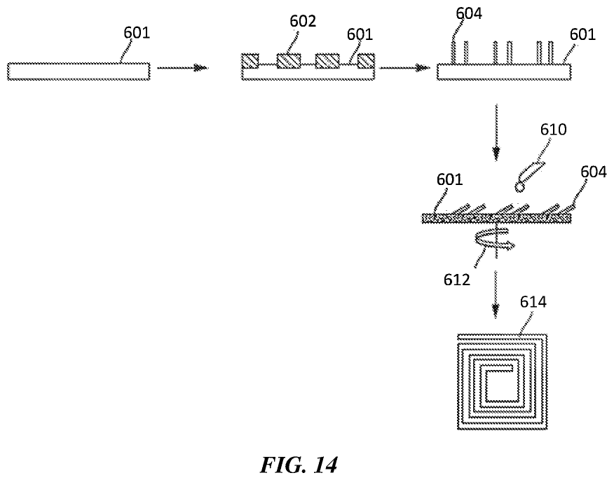

FIG. 14 is a schematic illustration of the fabrication of an inductor in which electronically conductive nanostructures are used to form the electronically conductive pathway of the inductor, in accordance with certain embodiments. In certain embodiments, substrate 601 is provided, and patterned with active growth material 602, such as a catalyst. The patterning may be performed, for example, using lithography masking techniques. According to some embodiments, a forest of vertically aligned patterned nanostructures 604 are grown on substrate 601, followed by knocking down the forest of vertically aligned patterned nanostructures, drop-casting electrically insulating material 610, and spin-coating 612, thereby providing inductor 614 comprising forest of substantially parallel patterned nanostructures 604 embedded in electrically insulating material 610 (e.g., a structural polymer matrix).

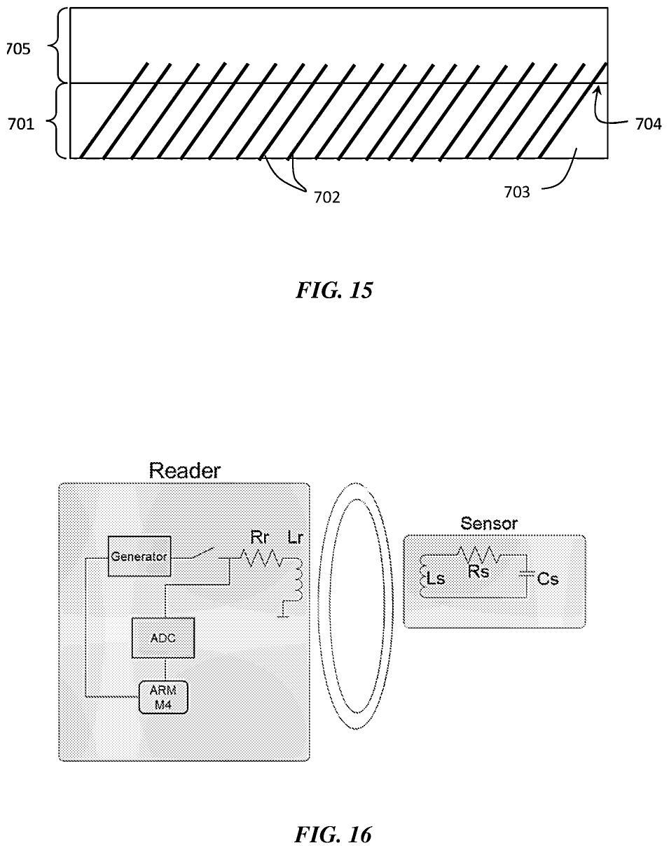

As noted above, in certain embodiments, elongated nanostructures within a circuit element (e.g., a capacitor or an inductor) may be used to mechanically reinforce an interface between the circuit element and adjacent layer material. In some embodiments, this can be achieved by arranging the long axes of the nanostructures of the circuit element such that they are embedded not only in the non-conductive material of the circuit element but also in the adjacent layer material (e.g., by having the elongated nanostructures penetrate the adjacent layer). One example of this type of arrangement is illustrated in FIG. 15. In FIG. 15, electronically conductive region 701 (which can be, for example, an electrode of any of the capacitors described herein and/or an electronically conductive pathway of any of the inductors described herein) comprises elongated nanostructures 702 embedded in a non-conductive matrix material 703. As shown in FIG. 15, elongated nanostructures 702 extend out from non-conductive matrix material 703 and penetrate into the surface 704 of adjacent layer 705 (which can correspond to, for example, layer 132 and/or layer 134 of FIGS. 1H, 2C, 3C, 4C, 5C, 6C, 7C, 8C, 9C, and/or 10C).

Non-limiting examples of the use of electronically conductive nanostructures embedded in non-conductive matrices to form circuit components and provide structural reinforcement are described, for example, in International Patent Application Publication No. WO 2019/118706, published on Jun. 20, 2019, filed on Dec. 13, 2018, as International Application No. PCT/US2018/065422, and entitled “Structural Electronics Wireless Sensor Nodes” and in U.S. patent application Ser. No. 16/900,159, filed on Jun. 12, 2020, published as U.S. Patent Publication No. 2020/0309674 on Oct. 1, 2020, and entitled “Structural Electronics Wireless Sensor Nodes,” each of which is incorporated herein by reference in its entirety for all purposes.

Any of a variety of suitable nanostructures can be used in association with the embodiments described herein. The term “nanostructure” is used herein in a manner consistent with its ordinary meaning in the art and refers to a structure that has a characteristic dimension, such as a cross-sectional diameter, or other appropriate dimension, that is greater than or equal to 1 nm and less than 1 micrometer. In some embodiments, the nanostructure has at least one characteristic dimension of less than 500 nm, less than 250 nm, less than 100 nm, less than 75 nm, less than 50 nm, less than 25 nm, less than 10 nm, or, in some cases, less than 5 nm.

In some embodiments, the nanostructures are elongated nanostructures (e.g., having an aspect ratio of at least 10, and in some embodiments, at least 100; at least 1,000; at least 10,000; at least 100,000; or more). In some embodiments, the elongated nanostructure is a nanofiber, a nanowire, a nanorod, or the like. In certain aspects, the nanostructures are electrically conductive.

In certain embodiments, the nanostructures comprise carbon-based nanostructures (i.e., nanostructures that are at least 50 atomic percent (at %) carbon and, in some cases, can be at least 60 at %, at least 70 at %, at least 80 at %, at least 90 at %, at least 95 at %, at least 99 at %, or more carbon). In certain embodiments, the nanostructures comprise carbon nanotubes (CNTs). The term “carbon nanotube” is used herein in a manner consistent with its ordinary meaning in the art and refers to a substantially cylindrical molecule or nanostructure comprising a fused network of primarily six-membered rings (e.g., six-membered aromatic rings) comprising primarily carbon atoms. Further details regarding CNTs are described below. In some embodiments, the nanostructures comprise metal. In some embodiments the metal is a conducting metal. For example, the nanostructure may comprise silicon (Si), germanium (Ge), gold (Au), metal oxides (e.g., In₂O₃, SnO₂, ZnO), and the like.

Additional examples of nanostructures that can be used include, but are not limited to, metal nanowires, conductive particles, buckyballs, graphene flakes, and the like.

In some embodiments, one or more circuit elements (e.g., the capacitor, the inductor) can comprise electronically conductive nanostructures embedded in a non-conductive matrix. Example of non-conductive matrices include, but are not limited to, polymers (e.g., epoxy resin (e.g., EPON resin), paramethylstyrene (PMS), para-methoxyamphetamine (PMA), polyimide (e.g., Kapton®), polyether ether ketone (PEEK), polyether ketone ketone (PEKK), bis-maleimide (BMI), cyanate ester, and the like), metal and/or metalloid oxides, glasses, ceramics, or any combinations of two or more of these materials.

As noted above, certain embodiments make use of multiple circuits. The use of multiple circuits can allow one to correct for changes to and/or differences in the environment (e.g., related to temperature, humidity, strain, creep, aging, etc.) when taking a measurement from the first circuit.

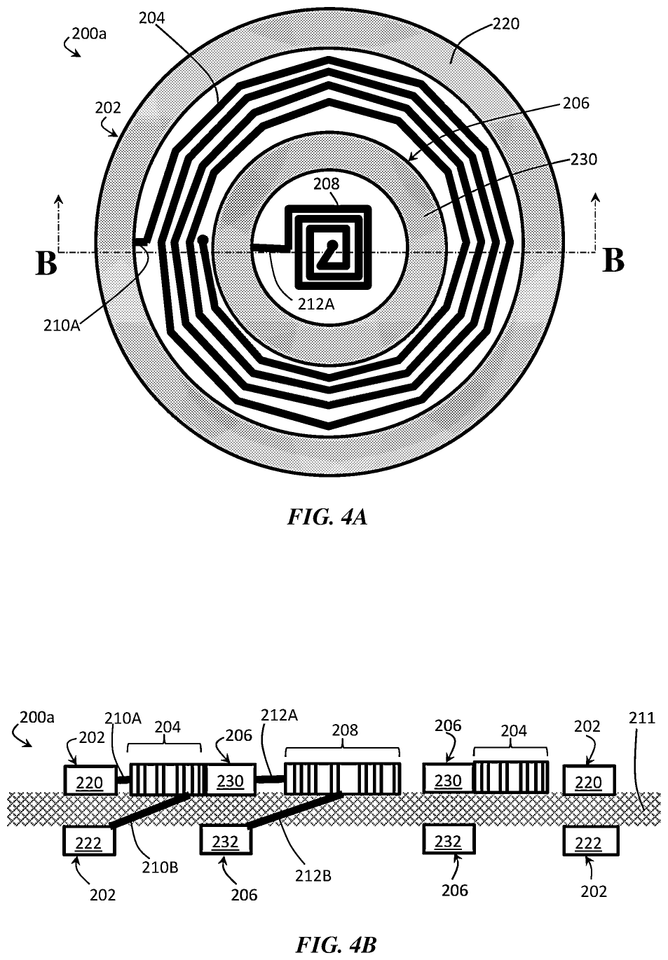

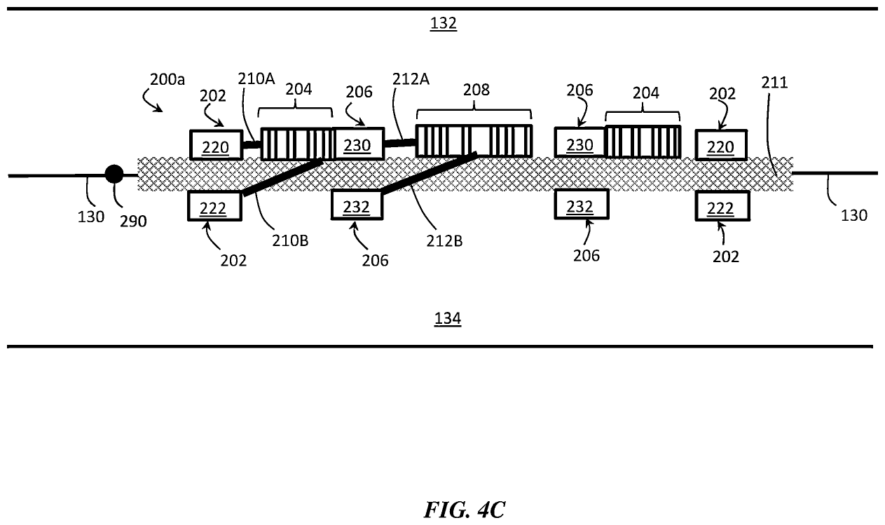

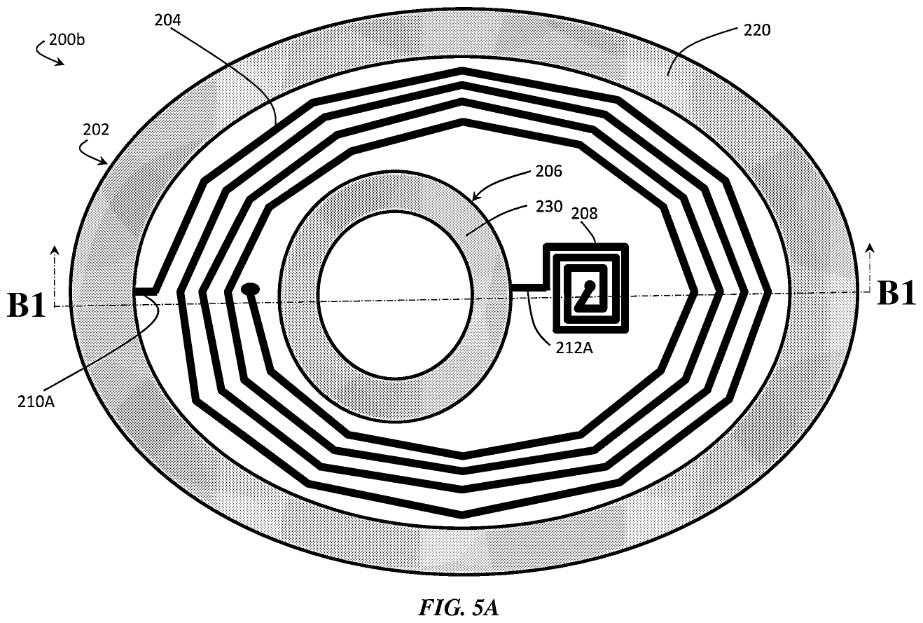

One example of an article comprising multiple circuits is illustrated in FIGS. 4A-4B. FIG. 4A is a top-view schematic illustration of article 200a, and FIG. 4B is a cross-sectional schematic illustration of article 200a taken along Section B-B of FIG. 4A. In FIG. 4A, article 200a comprises a first circuit comprising capacitor 202 and inductor 204 and a second circuit comprising capacitor 206 and inductor 208. Capacitor 202 is electronically coupled to inductor 204 via electronically conductive pathways 210A and 210B and capacitor 206 is electronically coupled to inductor 208 via electronically conductive pathways 212A and 212B. In addition, each of the first and second circuits can be associated with a solid body, such as a multi-layer material.

As illustrated in FIGS. 4A-4B, capacitors 202 and 206 are parallel-plate capacitors. Capacitor 202 comprises first electrode 220 and second electrode 222 (hidden from view in FIG. 4A by electrode 220). Capacitor 206 comprises first electrode 230 and second electrode 232 (hidden from view in FIG. 4A by electrode 230).

Although FIGS. 4A-4B depict that the capacitor of the second circuit is a parallel-plate capacitor, the capacitor of the second circuit may have any of a variety of suitable configurations. In certain embodiments, for example, the capacitor of the second circuit may be an interdigitated capacitor, although other configurations for the capacitor of the second circuit are also possible. For example, in some embodiments, capacitor 202 may be a parallel-plate capacitor and capacitor 206 may be an interdigitated capacitor. Examples of articles comprising multiple circuits, wherein the second circuit comprises an interdigitated capacitor, are explained herein in greater detail.

As described elsewhere herein, in some embodiments, the electrodes of the capacitor can comprise electronically conductive nanostructures (e.g., electronically conductive elongated nanostructures, such as carbon nanotubes) embedded within a non-conductive (e.g., electrically insulating) matrix. The nanostructures within the capacitor can be used, for example, to provide mechanical reinforcement between the capacitor electrode and adjacent structures (e.g., a layer of a multi-layer composite).

Capacitor 202 further comprises non-conductive material 211 between first electrode 220 and second electrode 222. Non-conductive material 211 is also used, in some embodiments, to physically separate first electrode 230 of capacitor 206 from second electrode 232 of capacitor 206. In some embodiments, it is advantageous to use a single non-conductive material layer to separate the electrodes of both the first and second capacitors, as shown in FIGS. 4A-4B, but in other embodiments, multiple non-conductive material layers can be used. Any of the non-conductive material types mentioned elsewhere herein can be used for non-conductive material 211.

Inductors 204 and 206 can assume any of a variety of configurations. In the embodiment illustrated in FIG. 4A, both inductor 204 and inductor 208 comprise an electronically conductive pathway arranged in a spiral shape, although other shapes and/or configurations are possible. In addition, as shown in FIG. 4A, inductor 204 substantially surrounds (and, in fact, completely surrounds) inductor 208. As described elsewhere herein, in some embodiments, the inductors can comprise electronically conductive nanostructures (e.g., electronically conductive elongated nanostructures, such as carbon nanotubes) embedded within a non-conductive (e.g., electrically insulating) matrix. The nanostructures within the inductor can be used, for example, to provide mechanical reinforcement between the inductor and adjacent structures (e.g., a layer of a multi-layer composite).

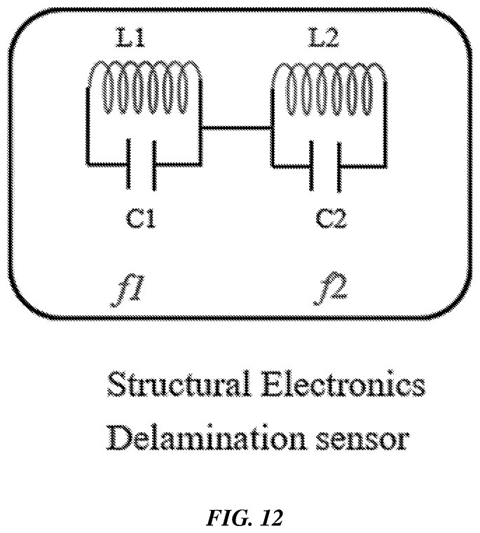

In the embodiment shown in FIGS. 4A-4B, inductor 204 is electronically coupled to capacitor 202 via electronically conductive pathways 210A and 210B. In particular, electronically conductive pathway 210A electronically couples one end of inductor 204 to electrode 220 of capacitor 202, and electronically conductive pathway 210B electronically couples a second end of inductor 204 (illustrated in FIG. 4A as a solid black circle) to electrode 222 of capacitor 202. When connected in this fashion, the capacitor and the inductor of the first circuit can form an RLC circuit, such as the circuit illustrated in the right-hand side of FIG. 12. In some embodiments, a dedicated resistor can be incorporated into the first circuit. In other embodiments, the intrinsic electrical resistivity of the circuit elements and/or the electronically conductive pathways coupling the circuit elements to each other can serve as the resistor of the RLC circuit.

Also, in the embodiment shown in FIGS. 4A-4B, inductor 208 is electronically coupled to capacitor 206 via electronically conductive pathways 212A and 212B. In particular, electronically conductive pathway 212A electronically couples one end of inductor 208 to electrode 230 of capacitor 206, and electronically conductive pathway 212B electronically couples a second end of inductor 208 (illustrated in FIG. 4A as a solid black circle) to electrode 232 of capacitor 206. When connected in this fashion, capacitor 206 and inductor 208 can also form an RLC circuit, such as the circuit illustrated in the left-hand side of FIG. 12. In some embodiments, a dedicated resistor can be incorporated into the circuit. In other embodiments, the intrinsic electrical resistivity of the circuit elements and/or the electronically conductive pathways coupling the circuit elements to each other can serve as the resistor of the RLC circuit.

In some embodiments, the capacitor of the first circuit substantially surrounds (or completely surrounds) the inductor of the second circuit and the capacitor of the second circuit. For example, in FIG. 4A, capacitor 202 of the first circuit completely surrounds both capacitor 206 of the second circuit and inductor 208 of the second circuit. Arranging the circuit elements in this way can allow one to use the first circuit to detect cracks, holes, or other structural defects while using the second circuit to account for changes in environment (e.g., related to temperature, humidity, strain, creep, aging, etc.) when taking a measurement from the first circuit, as explained in more detail below.

In certain embodiments, the capacitor of the first circuit also substantially surrounds (or completely surrounds) the inductor of the first circuit. For example, in FIG. 4A, capacitor 202 of the first circuit completely surrounds inductor 204 of the first circuit. Arranging the first circuit in this fashion can provide the benefits described above with respect to the RLC circuit shown in and described in relation to FIGS. 1A-1C.

In some embodiments, the first electrode and the second electrode of the capacitor of the first circuit each substantially surround (or completely surround) the inductor of the first circuit, the inductor of the second circuit, and the capacitor of the second circuit. For example, in FIG. 4A, first electrode 220 and second electrode 222 of capacitor 202 of the first circuit each substantially surround (and, in fact, completely surround) inductor 204 of the first circuit, inductor 208 of the second circuit, and capacitor 206 of the second circuit (including first electrode 230 of the capacitor of the second circuit and second electrode 232 of the capacitor of the second circuit).

In some embodiments, the capacitor of the second circuit substantially surrounds (or completely surrounds) the inductor of the second circuit. For example, in FIG. 4A, capacitor 206 of the second circuit completely surrounds inductor 208 of the second circuit. Arranging the second circuit in this fashion can provide the benefits described above with respect to the RLC circuit shown in and described in relation to FIGS. 1A-1C.

In some embodiments, the first electrode and the second electrode of the capacitor of the second circuit each substantially surround (or completely surround) the inductor of the second circuit. For example, in FIG. 4A, first electrode 230 and second electrode 232 of capacitor 206 of the second circuit each substantially surround (and, in fact, completely surround) inductor 208 of the second circuit.

In some embodiments, the first circuit is arranged such that, when viewed from at least one angle (e.g., an angle that is perpendicular to a capacitive surface of the capacitor of the first circuit, an angle that is perpendicular to an interface between two layers within which the first circuit and the second circuit are positioned) at least 50%, at least 75%, at least 85%, at least 90%, at least 95%, at least 98%, at least 99%, or all of the length of the two-dimensional convex hull of the capacitor of the first circuit has a portion of the capacitor of the first circuit positioned between it and the geometric center of the inductor of the first circuit. In some embodiments, the capacitor of the first circuit substantially surrounds (or completely surrounds) the inductor of the first circuit when viewed from this angle.

In some embodiments, the first and second circuits are arranged such that, when viewed from at least one angle (e.g., an angle that is perpendicular to a capacitive surface of the capacitor of the first circuit, an angle that is perpendicular to an interface between two layers within which the first circuit and the second circuit are positioned), at least 50%, at least 75%, at least 85%, at least 90%, at least 95%, at least 98%, at least 99%, or all of the length of the two-dimensional convex hull of the capacitor of the first circuit has a portion of the capacitor of the first circuit positioned between it and the geometric center of the inductor of the second circuit. In some embodiments, the capacitor of the first circuit substantially surrounds (or completely surrounds) the inductor of the second circuit when viewed from this angle.

In some embodiments, the first and second circuits are arranged such that, when viewed from at least one angle (e.g., an angle that is perpendicular to a capacitive surface of the capacitor of the first circuit, an angle that is perpendicular to an interface between two layers within which the first circuit and the second circuit are positioned), at least 50%, at least 75%, at least 85%, at least 90%, at least 95%, at least 98%, at least 99%, or all of the length of the two-dimensional convex hull of the capacitor of the first circuit has a portion of the capacitor of the first circuit positioned between it and the geometric center of the capacitor of the second circuit. In some embodiments, the capacitor of the first circuit substantially surrounds (or completely surrounds) the capacitor of the second circuit when viewed from this angle.

In some embodiments, the second circuit is arranged such that, when viewed from at least one angle (e.g., an angle that is perpendicular to a capacitive surface of the capacitor of the second circuit, an angle that is perpendicular to an interface between two layers within which the first circuit and the second circuit are positioned), at least 50%, at least 75%, at least 85%, at least 90%, at least 95%, at least 98%, at least 99%, or all of the length of the two-dimensional convex hull of the capacitor of the second circuit has a portion of the capacitor of the second circuit positioned between it and the geometric center of the inductor of the second circuit. In some embodiments, the capacitor of the second circuit substantially surrounds (or completely surrounds) the inductor of the second circuit when viewed from this angle.

As noted above, the sensors described herein can be associated with a solid body in any of a variety of suitable ways. In some embodiments, the first circuit and the second circuit are both part of a structure laminated to an external surface of the solid body.

In certain embodiments, the first circuit and the second circuit are located in an interlaminar region of a multi-layer article. For example, in some embodiments, the solid body with which the sensor is associated comprises a first layer and a second layer, where the first layer and the second layer define an interface. In some embodiments, the first circuit and the second circuit are both located at the interface between the first layer and the second layer. One example of this is illustrated in FIG. 4C. In FIG. 4C, the first circuit and the second circuit from FIGS. 4A-4B have been arranged at interface 130 between first layer 132 and second layer 134.

The first layer and/or the second layer of the multi-layer article can comprise any of a variety of materials. In some embodiments, the first layer and/or the second layer comprises a polymer (e.g., epoxy resin (e.g., EPON resin), paramethylstyrene (PMS), para-methoxyamphetamine (PMA), polyimide (e.g., Kapton®), polyether ether ketone (PEEK), polyether ketone ketone (PEKK), bis-maleimide (BMI), cyanate ester, and the like). In certain embodiments, the first layer and/or the second layer comprises a prepreg, as described elsewhere herein in further detail.

In some embodiments, a surface of the first electrode of the capacitor of the first circuit that faces the second electrode of the capacitor of the first circuit is substantially parallel to the interface between the first layer and the second layer, and a surface of the second electrode of the capacitor of the first circuit that faces the first electrode of the capacitor of the first circuit is substantially parallel to the interface between the first layer and the second layer. For example, referring to FIG. 4C, a surface of first electrode 220 of capacitor 202 that faces second electrode 222 of capacitor 202 is substantially parallel to interface 130 between first layer 132 and second layer 134. In addition, a surface of second electrode 222 of capacitor 202 that faces first electrode 220 of capacitor 202 is substantially parallel to interface 130 between first layer 132 and second layer 134.

In certain embodiments, a surface of the first electrode of the capacitor of the second circuit that faces the second electrode of the capacitor of the second circuit is substantially parallel to the interface between the first layer and the second layer, and a surface of the second electrode of the capacitor of the second circuit that faces the first electrode of the capacitor of the second circuit is substantially parallel to the interface between the first layer and the second layer. For example, referring to FIG. 4C, a surface of first electrode 230 of capacitor 206 that faces second electrode 232 of capacitor 206 is substantially parallel to interface 130 between first layer 132 and second layer 134. In addition, a surface of second electrode 232 of capacitor 206 that faces first electrode 230 of capacitor 206 is substantially parallel to interface 130 between first layer 132 and second layer 134.

In certain embodiments, the circuit can be configured such that cracks propagating in the interlaminar region of the multi-layer article will first propagate through the region of non-conductive material separating the electrodes of the capacitor of the first (outer) circuit before propagating through the region of non-conductive material separating the electrodes of the capacitor of the second (inner) circuit. This can be achieved, for example, by locating the capacitor of the first circuit such that it substantially surrounds the capacitor of the second circuit, and by aligning the regions of the non-conductive material for the capacitors of both the first and second circuits with the interface of the layers. In FIG. 4C, for example, non-conductive material 111 is in the form of a layer that is in contact with and substantially parallel to interface 130 between first layer 132 and second layer 134. In addition, capacitor 202 of the first circuit substantially surrounds capacitor 206 of the second circuit. In the embodiment shown in FIG. 4C, as a crack propagates through interface 130, it will come into contact with non-conductive material 111, and further crack propagation between first electrode 220 and second electrode 222 will be energetically favored relative to crack propagation elsewhere in the composite. Moreover, crack propagation between electrode 220 and electrode 222 will happen before crack propagation occurs between electrode 230 and electrode 232. As the crack propagates between electrodes 220 and 222, the capacitance of capacitor 202 will change while the capacitance of capacitor 206 will not change. By comparing the signals generated by capacitors 202 and 206 under these conditions, one can determine the portion of the change that is attributable to crack propagation and the portion of the change that is attributable to other environmental factors (e.g., temperature, humidity, strain, creep, aging, etc.).

In some embodiments, the capacitor and the inductor within a given circuit can be arranged such that a crack cannot propagate from an interlaminar region of a multi-layer article within which the circuit is located to an inductor of the circuit without passing through (1) the non-conductive material between the capacitor electrodes, (2) the first layer of the multi-layer article, or (3) the second layer of the multi-layer article. For example, in FIG. 4C, a crack cannot propagate from point 290 (which is in the interlaminar region of the multi-layer article within which the first and second circuits are located) to inductor 204 without passing through non-conductive region 211, through layer 132, or through layer 134. The second circuit is arranged similarly, such that a crack cannot propagate from point 290 (which is in the interlaminar region of the multi-layer article within which the first and second circuits are located) to inductor 208 without passing through non-conductive region 211, through layer 132, or through layer 134.

In some embodiments, the first circuit and the second circuit are arranged such that a crack cannot propagate from an interlaminar region of a multi-layer article within which the first and second circuit are located to an inductor or a capacitor of the second circuit without passing through (1) the non-conductive material between the capacitor electrodes of the first circuit or (2) the first layer of the multi-layer article, or (2) the second layer of the multi-layer article. For example, in FIG. 4C, it is not possible for a crack to propagate from point 290 to inductor 208 or to capacitor 206 without passing through non-conductive region 211, through the bulk of layer 132, or through the bulk of layer 134.

According to some embodiments, article 200a may comprise a structural defect (e.g., a crack) in non-conductive material 111 that has propagated from point 290. In some embodiments, the distance between electrodes 220 and 222 of capacitor 202 may be increased relative to the distance between electrodes 230 and 232 of capacitor 206, causing a change in the capacitance of capacitor 202 without a change in the capacitance of capacitor 206. In some embodiments, a user comparing the signals generated by capacitors 202 and 206 can determine the portion of the change that is attributable to crack propagation and the portion of the change that is attributable to other environmental factors (e.g., temperature, humidity, strain, creep, aging, etc.).

In some embodiments, the first and second layers form an interlaminar region. The interlaminar region can be, in some embodiments, less than or equal to 100 micrometers thick (e.g., from 5 micrometers to 100 micrometers thick). In some embodiments, the first and second layers form three regions: an upper ply (e.g., the region of layer 132 that is not within the interlaminar region), an interlaminar region, and a lower ply (e.g., the region of layer 134 that is not in the interlaminar region). In some embodiments, the interface between the first layer and the second layer (e.g., interface 130 in FIG. 4C) is part of an interlaminar region comprising only or substantially only polymer (e.g., polymer in an amount of at least 95 wt %, at least 98 wt %, at least 99 wt %, at least 99.9 wt %, or 100 wt %).

In some embodiments, the capacitor electrodes of the first circuit and/or the capacitor electrodes of the second circuit are positioned within the interlaminar region. The capacitive surfaces of the capacitors of the first circuit and/or the second circuit may, in some embodiments, follow the contour of the interlaminar region. In some embodiments, arranging the capacitor electrodes in this way ensures that it will only be energetically favorable for the crack to propagate through the interlaminar region.

As was the case in the single-circuit embodiments, nanostructures can be incorporated into one or more elements of the first circuit and/or the second circuit (e.g., into a capacitor and/or an inductor) in embodiments in which more than one circuit is employed. In some embodiments, the nanostructures can serve an electronic function of the circuit components. For example, in some embodiments, the nanostructures are electronically conductive and can be embedded in a non-conductive matrix to impart electronic conductivity to the circuit element. The nanostructures can also be used, in some embodiments, to mechanically reinforce one or more interfaces between a circuit element and an adjacent layer of the multi-layer laminate. Mechanically reinforcing the interface between the capacitor electrode(s) and the adjacent layer(s) and/or between the inductor and the adjacent layer can further increase the odds that cracks will propagate through the non-conductive region of the capacitor (as opposed to other parts of the circuit and/or the multi-layer material).

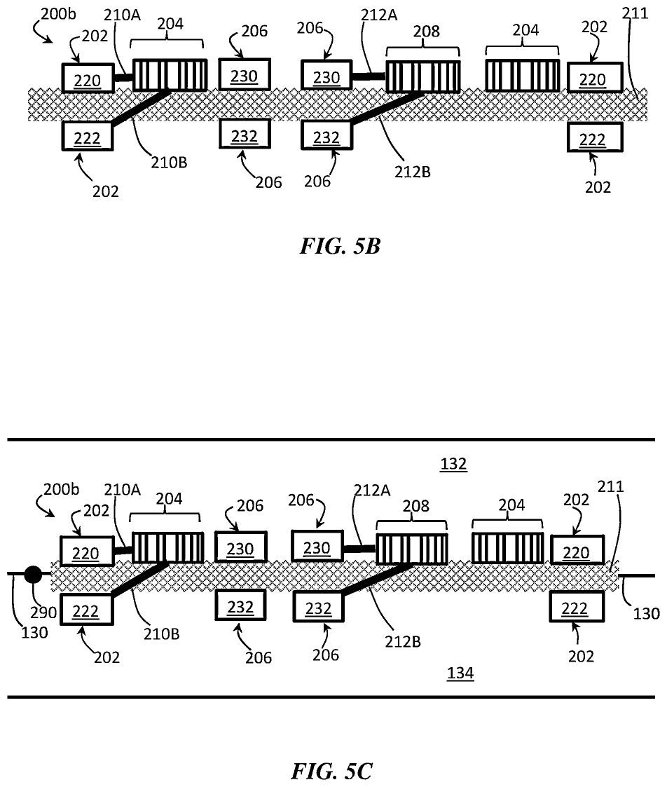

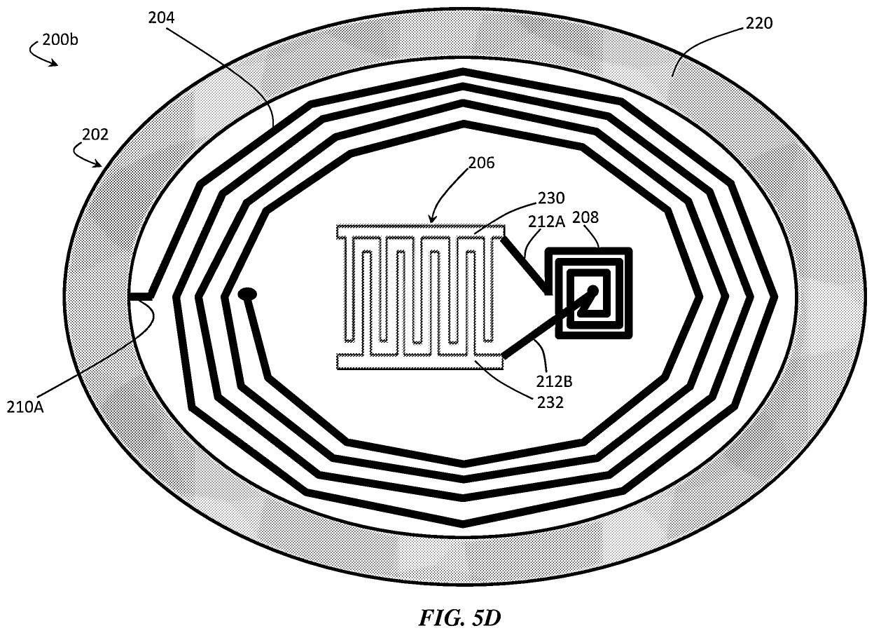

Another example of an article comprising multiple circuits is illustrated in FIGS. 5A-5B. FIG. 5A is a top-view schematic illustration of article 200b, and FIG. 5B is a cross-sectional schematic illustration of article 200b taken along Section B1-B1 of FIG. 5A. In FIG. 5A, article 200b comprises a first circuit comprising capacitor 202 and inductor 204 and a second circuit comprising capacitor 206 and inductor 208. Capacitor 202 is electronically coupled to inductor 204 via electronically conductive pathways 210A and 210B and capacitor 206 is electronically coupled to inductor 208 via electronically conductive pathways 212A and 212B. In addition, each of the first and second circuits can be associated with a solid body, such as a multi-layer material.

As illustrated in FIGS. 5A-5B, capacitors 202 and 206 are parallel-plate capacitors. Capacitor 202 comprises first electrode 220 and second electrode 222 (hidden from view in FIG. 5A by electrode 220). Capacitor 206 comprises first electrode 230 and second electrode 232 (hidden from view in FIG. 5A by electrode 230).

In other embodiments, as described elsewhere herein, the capacitor of the first circuit may be a parallel-plate capacitor and the capacitor of the second circuit may be an interdigitated capacitor. One example of such an article is shown in FIG. 5D. As shown in FIG. 5D, article 200h comprises a first circuit comprising capacitor 202 and inductor 204 and a second circuit comprising capacitor 206 and inductor 208. In some embodiments, capacitor 202 is a parallel-plate capacitor and capacitor 206 is an interdigitated capacitor. Capacitor 202 comprises first electrode 220 and second electrode 222 (hidden from view in FIG. 5D by electrode 220), and capacitor 206 comprises first electrode 230 and second electrode 232.

In the embodiment shown in FIG. 5D, inductor 204 is electronically coupled to capacitor 202 via electronically conductive pathways 210A and 210B (e.g., electronically conductive pathway 210A electronically couples one end of inductor 204 to electrode 220 of capacitor 202, and electronically conductive pathway 210B electronically couples a second end of inductor 204 (illustrated in FIG. 5D as a solid black circle) to electrode 222 of capacitor 202). Also, in the embodiment shown in FIG. 5D, inductor 208 is electronically coupled to capacitor 206 via electronically conductive pathways 212A and 212B (e.g., electronically conductive pathway 212A electronically couples one end of inductor 208 to electrode 230 of capacitor 206, and electronically conductive pathway 212B electronically couples a second end of inductor 208 (illustrated in FIG. 5D as a solid black circle) to electrode 232 of capacitor 206).

As described elsewhere herein, in some embodiments, the electrodes of the capacitor can comprise electronically conductive nanostructures (e.g., electronically conductive elongated nanostructures, such as carbon nanotubes) embedded within a non-conductive (e.g., electrically insulating) matrix. The nanostructures within the capacitor can be used, for example, to provide mechanical reinforcement between the capacitor electrode and adjacent structures (e.g., a layer of a multi-layer composite).

In the embodiment illustrated in FIGS. 5A-5B, capacitor 202 further comprises non-conductive material 211 between first electrode 220 and second electrode 222. Non-conductive material 211 is also used to physically separate first electrode 230 of capacitor 206 from second electrode 232 of capacitor 206. In some embodiments, it is advantageous to use a single non-conductive material layer to separate the electrodes of both the first and second capacitors, as shown in FIGS. 5A-5B, but in other embodiments, multiple non-conductive material layers can be used. Any of the non-conductive material types mentioned elsewhere herein can be used for non-conductive material 211.

In the embodiment illustrated in FIG. 5A, both inductor 204 and inductor 208 comprise an electronically conductive pathway arranged in a spiral shape, although other shapes and/or configurations are possible. In addition, as shown in FIG. 5A, inductor 204 substantially surrounds (and, in fact, completely surrounds) inductor 208. As described elsewhere herein, in some embodiments, the inductors can comprise electronically conductive nanostructures (e.g., electronically conductive elongated nanostructures, such as carbon nanotubes) embedded within a non-conductive (e.g., electrically insulating) matrix. The nanostructures within the inductor can be used, for example, to provide mechanical reinforcement between the inductor and adjacent structures (e.g., a layer of a multi-layer composite).

In the embodiment shown in FIGS. 5A-5B, inductor 204 is electronically coupled to capacitor 202 via electronically conductive pathways 210A and 210B. In particular, electronically conductive pathway 210A electronically couples one end of inductor 204 to electrode 220 of capacitor 202, and electronically conductive pathway 210B electronically couples a second end of inductor 204 (illustrated in FIG. 5A as a solid black circle) to electrode 222 of capacitor 202. When connected in this fashion, the capacitor and the inductor of the first circuit can form an RLC circuit, such as the circuit illustrated in the right-hand side of FIG. 12. In some embodiments, a dedicated resistor can be incorporated into the first circuit. In other embodiments, the intrinsic electrical resistivity of the circuit elements and/or the electronically conductive pathways coupling the circuit elements to each other can serve as the resistor of the RLC circuit.

Also, in the embodiment shown in FIGS. 5A-5B, inductor 208 is electronically coupled to capacitor 206 via electronically conductive pathways 212A and 212B. In particular, electronically conductive pathway 212A electronically couples one end of inductor 208 to electrode 230 of capacitor 206, and electronically conductive pathway 212B electronically couples a second end of inductor 208 (illustrated in FIG. 5A as a solid black circle) to electrode 232 of capacitor 206. When connected in this fashion, capacitor 206 and inductor 208 can also form an RLC circuit, such as the circuit illustrated in the left-hand side of FIG. 12. In some embodiments, a dedicated resistor can be incorporated into the circuit. In other embodiments, the intrinsic electrical resistivity of the circuit elements and/or the electronically conductive pathways coupling the circuit elements to each other can serve as the resistor of the RLC circuit.

In some embodiments, capacitor 202 of the first circuit substantially surrounds (or completely surrounds, as shown in FIG. 5A) capacitor 206 of the second circuit and inductor 208 of the second circuit. Arranging the circuit elements in this fashion can provide the benefits described above with respect to the RLC circuits shown in and described in FIGS. 4A-4C.

In certain embodiments, capacitor 202 of the first circuit also substantially surrounds (or completely surrounds, as shown in FIG. 5A) inductor 204 of the first circuit. Arranging the first circuit in this fashion can provide the benefits described above with respect to the RLC circuit shown in and described in relation to FIGS. 1A-1C.

In some embodiments, first electrode 220 and second electrode 222 of capacitor 202 of the first circuit each substantially surround (or completely surround, as shown in FIG. 5A) inductor 204 of the first circuit, inductor 208 of the second circuit, and capacitor 206 of the second circuit (including first electrode 230 of the capacitor of the second circuit and second electrode 232 of the capacitor of the second circuit).

In some embodiments, the capacitor of the second circuit and the inductor of the second circuit may be arranged such that the capacitor of the second circuit is positioned alongside (e.g., adjacent to) the inductor. For example, in FIG. 5A, capacitor 206 of the second circuit is positioned alongside (e.g., adjacent to) inductor 208 of the second circuit. Arranging the second circuit in this fashion can provide the benefits described above with respect to the RLC circuit shown in and described in relation to FIGS. 2A-2C.

According to some embodiments, article 200b shown in FIGS. 5A-5B may be located in an interlaminar region of a multi-layer article. For example, in some embodiments, article 200b may be located at an interface between a first layer and a second layer of a solid body. One example of this is illustrated in FIG. 5C. In FIG. 5C, article 200b from FIGS. 5A-5B has been arranged at interface 130 between first layer 132 and second layer 134 of a solid body. The first layer and/or the second layer of the multi-layer article may comprise any of a variety of materials described elsewhere herein.

According to some embodiments, and as shown in FIG. 5C, a surface of first electrode 220 of capacitor 202 that faces second electrode 222 of capacitor 202 is substantially parallel to interface 130 between first layer 132 and second layer 134. In addition, a surface of second electrode 222 of capacitor 202 that faces first electrode 220 of capacitor 202 is substantially parallel to interface 130 between first layer 132 and second layer 134.

In some embodiments, and as shown in FIG. 5C, a surface of first electrode 230 of capacitor 206 that faces second electrode 232 of capacitor 206 is substantially parallel to interface 130 between first layer 132 and second layer 134. In addition, a surface of second electrode 232 of capacitor 206 that faces first electrode 230 of capacitor 206 is substantially parallel to interface 130 between first layer 132 and second layer 134.

According to certain embodiments, and as shown in FIG. 5C, non-conductive material 111 is in the form of a layer that is in contact with and substantially parallel to interface 130 between first layer 132 and second layer 134. In addition, capacitor 202 of the first circuit substantially surrounds capacitor 206 of the second circuit. In the embodiment shown in FIG. 5C, as a crack propagates through interface 130, it will come into contact with non-conductive material 111, and further crack propagation between first electrode 220 and second electrode 222 will be energetically favored relative to crack propagation elsewhere in the composite. Moreover, crack propagation between electrode 220 and electrode 222 will happen before crack propagation occurs between electrode 230 and electrode 232. As the crack propagates between electrodes 220 and 222, the capacitance of capacitor 202 will change while the capacitance of capacitor 206 will not change. By comparing the signals generated by capacitors 202 and 206 under these conditions, one can determine the portion of the change that is attributable to crack propagation and the portion of the change that is attributable to other environmental factors (e.g., temperature, humidity, strain, creep, aging, etc.).

In some embodiments, and as shown in FIG. 5C, a crack cannot propagate from point 290 (which is in the interlaminar region of the multi-layer article within which the first and second circuits are located) to inductor 204 without passing through non-conductive region 211, through layer 132, or through layer 134. The second circuit is arranged similarly, such that a crack cannot propagate from point 290 (which is in the interlaminar region of the multi-layer article within which the first and second circuits are located) to inductor 208 without passing through non-conductive region 211, through layer 132, or through layer 134.

According to certain embodiments, and as shown in FIG. 5C, it is not possible for a crack to propagate from point 290 to inductor 208 or to capacitor 206 without passing through non-conductive region 211, through the bulk of layer 132, or through the bulk of layer 134.

According to some embodiments, article 200b may comprise a structural defect (e.g., a crack) in non-conductive material 111 that has propagated from point 290. In some embodiments, the distance between electrodes 220 and 222 of capacitor 202 may be increased relative to the distance between electrodes 230 and 232 of capacitor 206, causing a change in the capacitance of capacitor 202 without a change in the capacitance of capacitor 206. In some embodiments, a user comparing the signals generated by capacitors 202 and 206 can determine the portion of the change that is attributable to crack propagation and the portion of the change that is attributable to other environmental factors (e.g., temperature, humidity, strain, creep, aging, etc.).

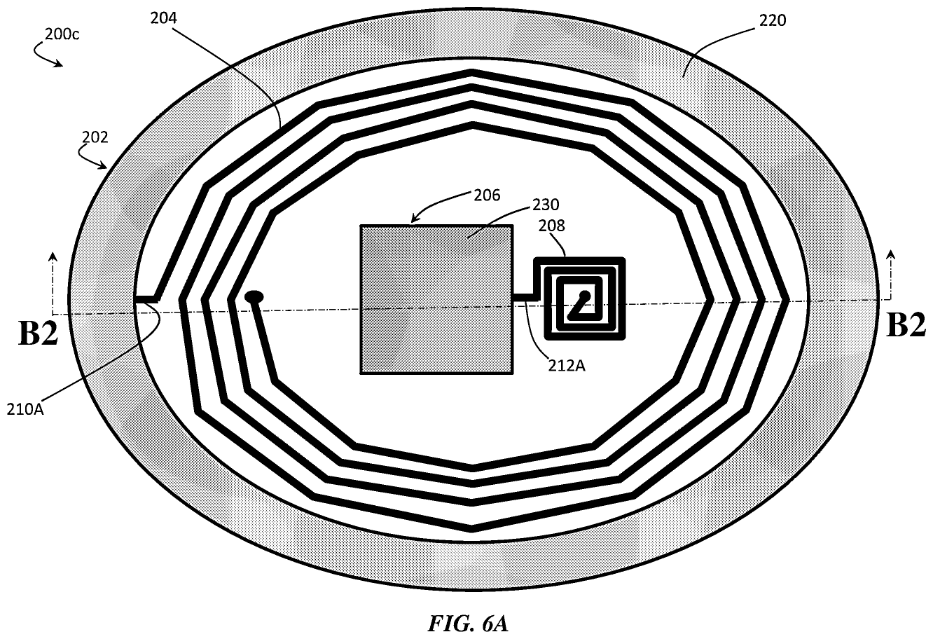

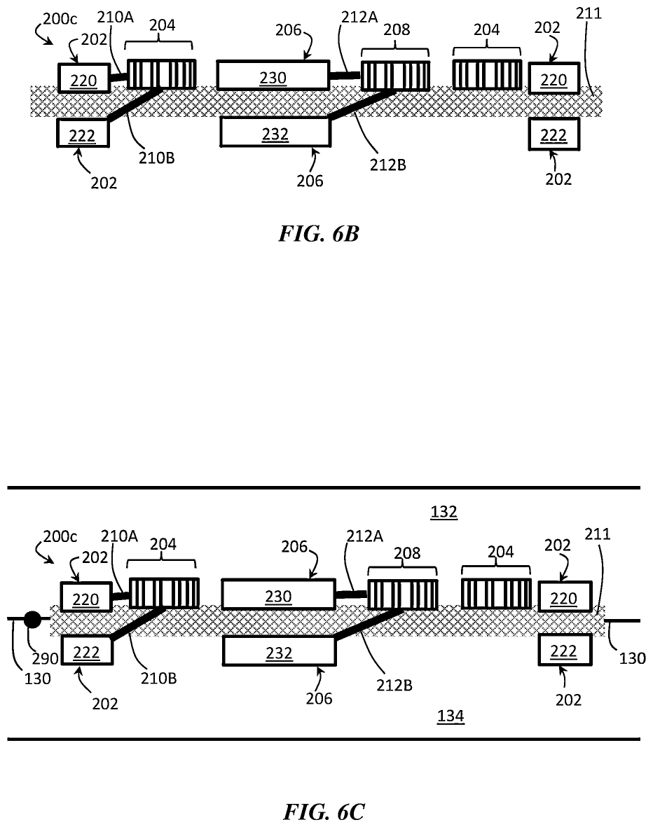

According to certain embodiments related to articles comprising multiple circuits, at least one capacitor of at least one circuit may have a square shape. One example of such an article is shown in FIGS. 6A-6C. FIG. 6A is a top-view schematic illustration of article 200c comprising a first circuit comprising capacitor 202 and inductor 204 and a second circuit comprising capacitor 206 and inductor 208, wherein capacitor 206 of the second circuit has a square shape, and FIG. 6B is a cross-sectional schematic illustration of article 200c taken along Section B2-B2 of FIG. 6A Article 200c otherwise functions the same as article 200b shown in and described in relation to FIGS. 5A-5B, while also providing the benefits described above with respect to the RLC circuit shown in and described in relation to FIGS. 3A-3B.

Although the embodiment in FIG. 6A shows that the capacitor of the first circuit has a circular shape and the capacitor of the second circuit has a square shape, the capacitor of the first circuit may, in some embodiments, have a square shape instead of, or in addition to, the second circuit having a square shape.

According to some embodiments, article 200c shown in FIGS. 6A-6B may be located in an interlaminar region of a multi-layer article. For example, in some embodiments, article 200c may be located at an interface between a first layer and a second layer of a solid body. One example of this is illustrated in FIG. 6C. In some embodiments, article 200c located at an interface between a first layer and a second layer of a solid body may function the same as article 200b shown in and described in relation to FIG. 5C.

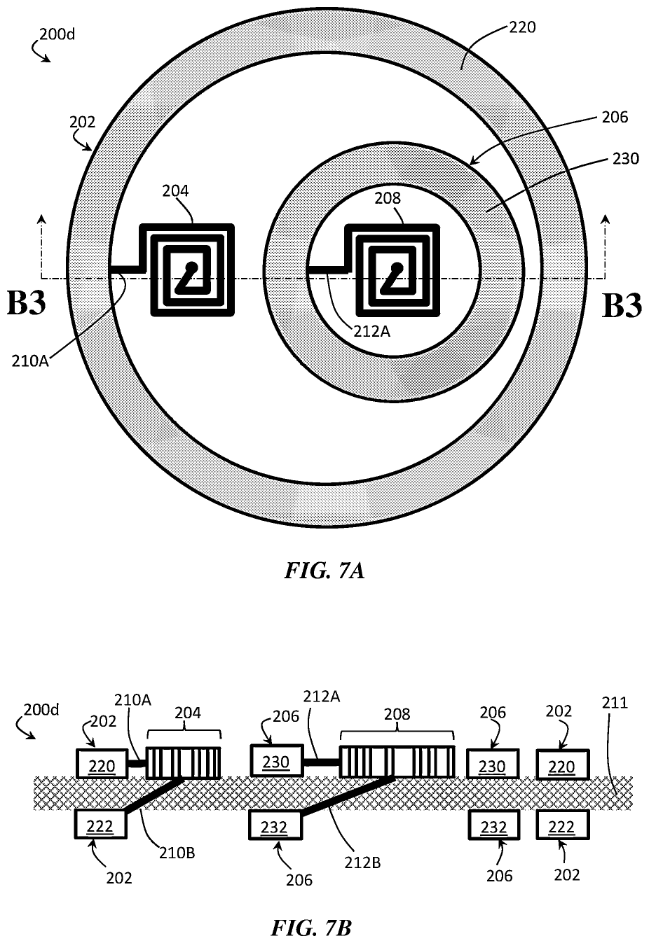

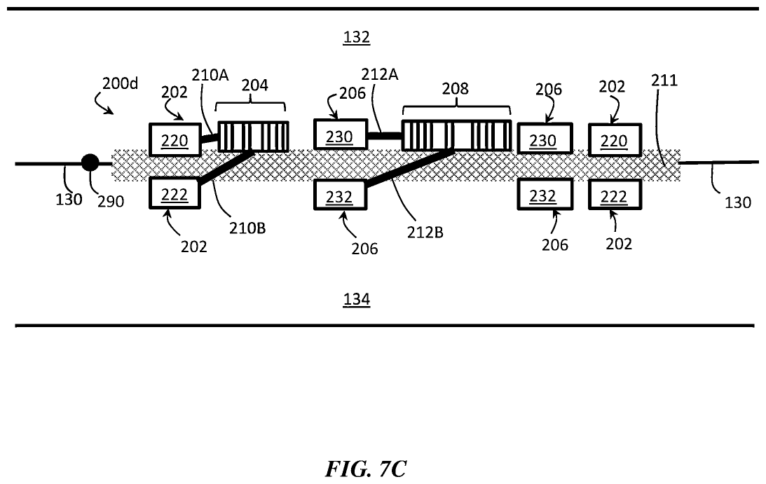

Yet another example of an article comprising multiple circuits is illustrated in FIGS. 7A-7B. FIG. 7A is a top-view schematic illustration of article 200d, and FIG. 7B is a cross-sectional schematic illustration of article 200d taken along Section B3-B3 of FIG. 7A. In FIG. 7A, article 200d comprises a first circuit comprising capacitor 202 and inductor 204 and a second circuit comprising capacitor 206 and inductor 208. Capacitor 202 is electronically coupled to inductor 204 via electronically conductive pathways 210A and 210B and capacitor 206 is electronically coupled to inductor 208 via electronically conductive pathways 212A and 212B. In addition, each of the first and second circuits can be associated with a solid body, such as a multi-layer material.

As illustrated in FIGS. 7A-7B, capacitors 202 and 206 are parallel-plate capacitors. Capacitor 202 comprises first electrode 220 and second electrode 222 (hidden from view in FIG. 7A by electrode 220). Capacitor 206 comprises first electrode 230 and second electrode 232 (hidden from view in FIG. 7A by electrode 230). In other embodiments, as described elsewhere herein, capacitor 202 may be a parallel-plate capacitor and capacitor 206 may be an interdigitated capacitor.

As described elsewhere herein, in some embodiments, the electrodes of the capacitor can comprise electronically conductive nanostructures (e.g., electronically conductive elongated nanostructures, such as carbon nanotubes) embedded within a non-conductive (e.g., electrically insulating) matrix. The nanostructures within the capacitor can be used, for example, to provide mechanical reinforcement between the capacitor electrode and adjacent structures (e.g., a layer of a multi-layer composite).

Capacitor 202 further comprises non-conductive material 211 between first electrode 220 and second electrode 222. Non-conductive material 211 is also used to physically separate first electrode 230 of capacitor 206 from second electrode 232 of capacitor 206. In some embodiments, it is advantageous to use a single non-conductive material layer to separate the electrodes of both the first and second capacitors, as shown in FIGS. 7A-7B, but in other embodiments, multiple non-conductive material layers can be used. Any of the non-conductive material types mentioned elsewhere herein can be used for non-conductive material 211.

In the embodiment illustrated in FIG. 7A, both inductor 204 and inductor 208 comprise an electronically conductive pathway arranged in a spiral shape, although other shapes and/or configurations are possible. As described elsewhere herein, in some embodiments, the inductors can comprise electronically conductive nanostructures (e.g., electronically conductive elongated nanostructures, such as carbon nanotubes) embedded within a non-conductive (e.g., electrically insulating) matrix. The nanostructures within the inductor can be used, for example, to provide mechanical reinforcement between the inductor and adjacent structures (e.g., a layer of a multi-layer composite).

In the embodiment shown in FIGS. 7A-7B, inductor 204 is electronically coupled to capacitor 202 via electronically conductive pathways 210A and 210B. In particular, electronically conductive pathway 210A electronically couples one end of inductor 204 to electrode 220 of capacitor 202, and electronically conductive pathway 210B electronically couples a second end of inductor 204 (illustrated in FIG. 7A as a solid black circle) to electrode 222 of capacitor 202. When connected in this fashion, the capacitor and the inductor of the first circuit can form an RLC circuit, such as the circuit illustrated in the right-hand side of FIG. 12. In some embodiments, a dedicated resistor can be incorporated into the first circuit. In other embodiments, the intrinsic electrical resistivity of the circuit elements and/or the electronically conductive pathways coupling the circuit elements to each other can serve as the resistor of the RLC circuit.

Also, in the embodiment shown in FIGS. 7A-7B, inductor 208 is electronically coupled to capacitor 206 via electronically conductive pathways 212A and 212B. In particular, electronically conductive pathway 212A electronically couples one end of inductor 208 to electrode 230 of capacitor 206, and electronically conductive pathway 212B electronically couples a second end of inductor 208 (illustrated in FIG. 7A as a solid black circle) to electrode 232 of capacitor 206. When connected in this fashion, capacitor 206 and inductor 208 can also form an RLC circuit, such as the circuit illustrated in the left-hand side of FIG. 12. In some embodiments, a dedicated resistor can be incorporated into the circuit. In other embodiments, the intrinsic electrical resistivity of the circuit elements and/or the electronically conductive pathways coupling the circuit elements to each other can serve as the resistor of the RLC circuit.

In some embodiments, capacitor 202 of the first circuit substantially surrounds (or completely surrounds, as shown in FIG. 7A) capacitor 206 of the second circuit and inductor 208 of the second circuit. Arranging the circuit elements in this fashion can provide the benefits described above with respect to the RLC circuits shown in and described in FIGS. 4A-4C.

In certain embodiments, capacitor 202 of the first circuit also substantially surrounds (or completely surrounds, as shown in FIG. 7A) inductor 204 of the first circuit. Arranging the first circuit in this fashion can provide the benefits described above with respect to the RLC circuit shown in and described in relation to FIGS. 1A-1C.

In some embodiments, first electrode 220 and second electrode 222 of capacitor 202 of the first circuit each substantially surround (or completely surround, as shown in FIG. 7A) inductor 204 of the first circuit, inductor 208 of the second circuit, and capacitor 206 of the second circuit (including first electrode 230 of the capacitor of the second circuit and second electrode 232 of the capacitor of the second circuit).

In some embodiments, capacitor 206 of the second circuit substantially surrounds (or completely surrounds, as shown in FIG. 7A) inductor 208 of the second circuit. Arranging the second circuit in this fashion can provide the benefits described above with respect to the RLC circuit shown in and described in relation to FIGS. 1A-1C.

In some embodiments, and as shown in FIG. 7A, first electrode 230 and second electrode 232 of capacitor 206 of the second circuit each substantially surround (and, in fact, completely surround) inductor 208 of the second circuit.

According to some embodiments article 200d shown in FIGS. 7A-7B may be located in an interlaminar region of a multi-layer article. For example, in some embodiments, article 200d may be located at an interface between a first layer and a second layer of a solid body. One example of this is illustrated in FIG. 7C. In FIG. 7C, article 200d from FIGS. 7A-7B has been arranged at interface 130 between first layer 132 and second layer 134 of a solid body. The first layer and/or the second layer of the multi-layer article may comprise any of a variety of materials described elsewhere herein.

According to some embodiments, and as shown in FIG. 7C, a surface of first electrode 220 of capacitor 202 that faces second electrode 222 of capacitor 202 is substantially parallel to interface 130 between first layer 132 and second layer 134. In addition, a surface of second electrode 222 of capacitor 202 that faces first electrode 220 of capacitor 202 is substantially parallel to interface 130 between first layer 132 and second layer 134.

In some embodiments, and as shown in FIG. 7C, a surface of first electrode 230 of capacitor 206 that faces second electrode 232 of capacitor 206 is substantially parallel to interface 130 between first layer 132 and second layer 134. In addition, a surface of second electrode 232 of capacitor 206 that faces first electrode 230 of capacitor 206 is substantially parallel to interface 130 between first layer 132 and second layer 134.

According to certain embodiments, and as shown in FIG. 7C, non-conductive material 111 is in the form of a layer that is in contact with and substantially parallel to interface 130 between first layer 132 and second layer 134. In addition, capacitor 202 of the first circuit substantially surrounds capacitor 206 of the second circuit. In the embodiment shown in FIG. 7C, as a crack propagates through interface 130, it will come into contact with non-conductive material 111, and further crack propagation between first electrode 220 and second electrode 222 will be energetically favored relative to crack propagation elsewhere in the composite. Moreover, crack propagation between electrode 220 and electrode 222 will happen before crack propagation occurs between electrode 230 and electrode 232. As the crack propagates between electrodes 220 and 222, the capacitance of capacitor 202 will change while the capacitance of capacitor 206 will not change. By comparing the signals generated by capacitors 202 and 206 under these conditions, one can determine the portion of the change that is attributable to crack propagation and the portion of the change that is attributable to other environmental factors (e.g., temperature, humidity, strain, creep, aging, etc.).

In some embodiments, and as shown in FIG. 7C, a crack cannot propagate from point 290 (which is in the interlaminar region of the multi-layer article within which the first and second circuits are located) to inductor 204 without passing through non-conductive region 211, through layer 132, or through layer 134. The second circuit is arranged similarly, such that a crack cannot propagate from point 290 (which is in the interlaminar region of the multi-layer article within which the first and second circuits are located) to inductor 208 without passing through non-conductive region 211, through layer 132, or through layer 134.

According to certain embodiments, and as shown in FIG. 7C, it is not possible for a crack to propagate from point 290 to inductor 208 or to capacitor 206 without passing through non-conductive region 211, through the bulk of layer 132, or through the bulk of layer 134.

According to some embodiments, article 200d may comprise a structural defect (e.g., a crack) in non-conductive material 111 that has propagated from point 290. In some embodiments, the distance between electrodes 220 and 222 of capacitor 202 may be increased relative to the distance between electrodes 230 and 232 of capacitor 206, causing a change in the capacitance of capacitor 202 without a change in the capacitance of capacitor 206. In some embodiments, a user comparing the signals generated by capacitors 202 and 206 can determine the portion of the change that is attributable to crack propagation and the portion of the change that is attributable to other environmental factors (e.g., temperature, humidity, strain, creep, aging, etc.).

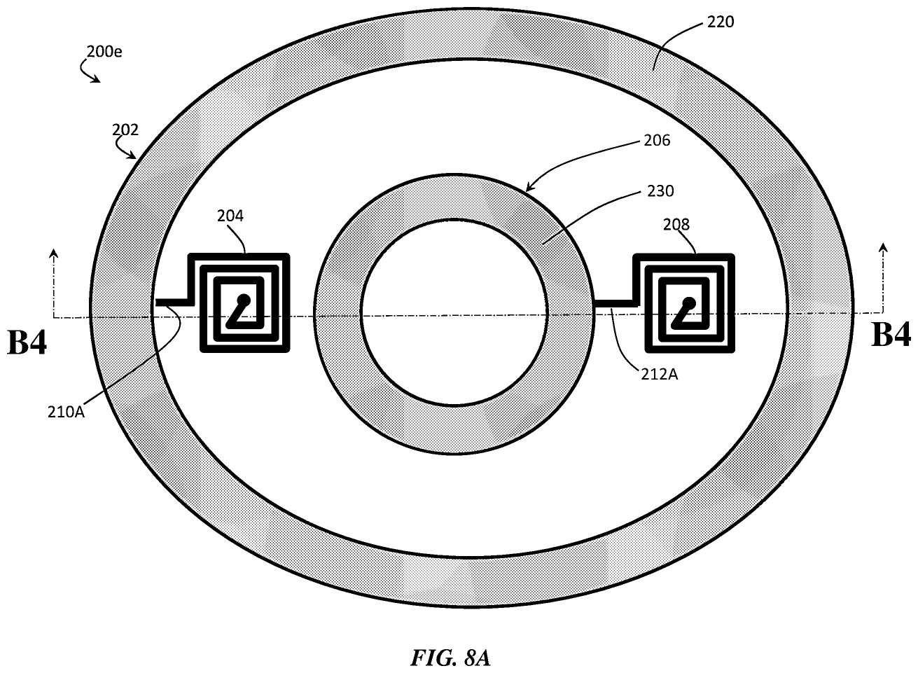

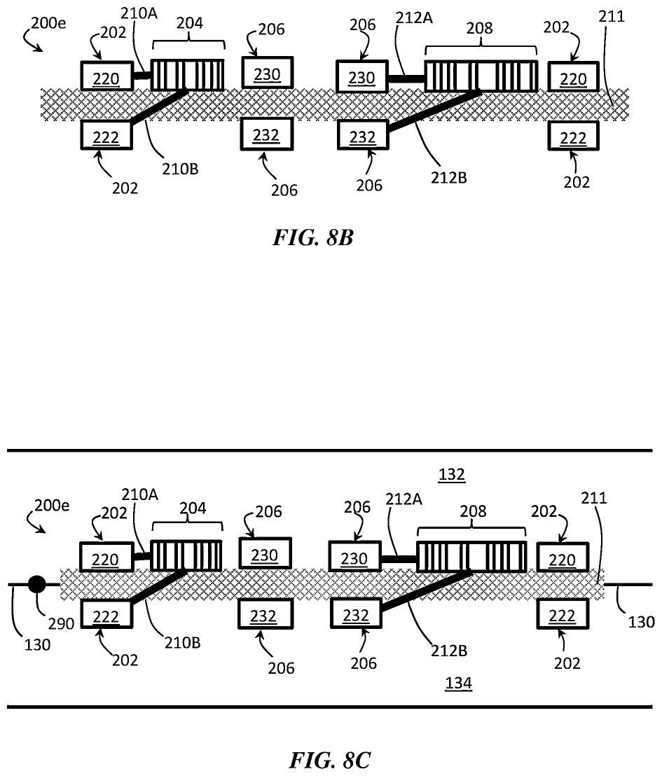

Yet another example of an article comprising multiple circuits is illustrated in FIGS. 8A-8B. FIG. 8A is a top-view schematic illustration of article 200e, and FIG. 8B is a cross-sectional schematic illustration of article 200e taken along Section B4-B4 of FIG. 8A. In FIG. 8A, article 200e comprises a first circuit comprising capacitor 202 and inductor 204 and a second circuit comprising capacitor 206 and inductor 208. Capacitor 202 is electronically coupled to inductor 204 via electronically conductive pathways 210A and 210B and capacitor 206 is electronically coupled to inductor 208 via electronically conductive pathways 212A and 212B. In addition, each of the first and second circuits can be associated with a solid body, such as a multi-layer material.

As illustrated in FIGS. 8A-8B, capacitors 202 and 206 are parallel-plate capacitors. Capacitor 202 comprises first electrode 220 and second electrode 222 (hidden from view in FIG. 8A by electrode 220). Capacitor 206 comprises first electrode 230 and second electrode 232 (hidden from view in FIG. 8A by electrode 230). In other embodiments, as described elsewhere herein, capacitor 202 may be a parallel-plate capacitor and capacitor 206 may be an interdigitated capacitor.

As described elsewhere herein, in some embodiments, the electrodes of the capacitor can comprise electronically conductive nanostructures (e.g., electronically conductive elongated nanostructures, such as carbon nanotubes) embedded within a non-conductive (e.g., electrically insulating) matrix. The nanostructures within the capacitor can be used, for example, to provide mechanical reinforcement between the capacitor electrode and adjacent structures (e.g., a layer of a multi-layer composite).

Capacitor 202 further comprises non-conductive material 211 between first electrode 220 and second electrode 222. Non-conductive material 211 is also used to physically separate first electrode 230 of capacitor 206 from second electrode 232 of capacitor 206. In some embodiments, it is advantageous to use a single non-conductive material layer to separate the electrodes of both the first and second capacitors, as shown in FIGS. 8A-8B, but in other embodiments, multiple non-conductive material layers can be used. Any of the non-conductive material types mentioned elsewhere herein can be used for non-conductive material 211.

In the embodiment illustrated in FIG. 8A, both inductor 204 and inductor 208 comprise an electronically conductive pathway arranged in a spiral shape, although other shapes and/or configurations are possible. As described elsewhere herein, in some embodiments, the inductors can comprise electronically conductive nanostructures (e.g., electronically conductive elongated nanostructures, such as carbon nanotubes) embedded within a non-conductive (e.g., electrically insulating) matrix. The nanostructures within the inductor can be used, for example, to provide mechanical reinforcement between the inductor and adjacent structures (e.g., a layer of a multi-layer composite).

In the embodiment shown in FIGS. 8A-8B, inductor 204 is electronically coupled to capacitor 202 via electronically conductive pathways 210A and 210B. In particular, electronically conductive pathway 210A electronically couples one end of inductor 204 to electrode 220 of capacitor 202, and electronically conductive pathway 210B electronically couples a second end of inductor 204 (illustrated in FIG. 8A as a solid black circle) to electrode 222 of capacitor 202. When connected in this fashion, the capacitor and the inductor of the first circuit can form an RLC circuit, such as the circuit illustrated in the right-hand side of FIG. 12. In some embodiments, a dedicated resistor can be incorporated into the first circuit. In other embodiments, the intrinsic electrical resistivity of the circuit elements and/or the electronically conductive pathways coupling the circuit elements to each other can serve as the resistor of the RLC circuit.

Also, in the embodiment shown in FIGS. 8A-8B, inductor 208 is electronically coupled to capacitor 206 via electronically conductive pathways 212A and 212B. In particular, electronically conductive pathway 212A electronically couples one end of inductor 208 to electrode 230 of capacitor 206, and electronically conductive pathway 212B electronically couples a second end of inductor 208 (illustrated in FIG. 8A as a solid black circle) to electrode 232 of capacitor 206. When connected in this fashion, capacitor 206 and inductor 208 can also form an RLC circuit, such as the circuit illustrated in the left-hand side of FIG. 12. In some embodiments, a dedicated resistor can be incorporated into the circuit. In other embodiments, the intrinsic electrical resistivity of the circuit elements and/or the electronically conductive pathways coupling the circuit elements to each other can serve as the resistor of the RLC circuit.

In some embodiments, capacitor 202 of the first circuit substantially surrounds (or completely surrounds, as shown in FIG. 8A) capacitor 206 of the second circuit and inductor 208 of the second circuit. Arranging the circuit elements in this fashion can provide the benefits described above with respect to the RLC circuits shown in and described in FIGS. 4A-4C.

In certain embodiments, capacitor 202 of the first circuit also substantially surrounds (or completely surrounds, as shown in FIG. 8A) inductor 204 of the first circuit. Arranging the first circuit in this fashion can provide the benefits described above with respect to the RLC circuit shown in and described in relation to FIGS. 1A-1C.

In some embodiments, first electrode 220 and second electrode 222 of capacitor 202 of the first circuit each substantially surround (or completely surround, as shown in FIG. 8A) inductor 204 of the first circuit, inductor 208 of the second circuit, and capacitor 206 of the second circuit (including first electrode 230 of the capacitor of the second circuit and second electrode 232 of the capacitor of the second circuit).

In certain embodiments, and as shown in FIG. 8A, capacitor 206 of the second circuit is positioned alongside (e.g., adjacent to) inductor 208 of the second circuit. Arranging the second circuit in this fashion can provide the benefits described above with respect to the RLC circuit shown in and described in relation to FIGS. 2A-2C.

According to some embodiments article 200e shown in FIGS. 8A-8B may be located in an interlaminar region of a multi-layer article. For example, in some embodiments, article 200e may be located at an interface between a first layer and a second layer of a solid body. One example of this is illustrated in FIG. 8C. In FIG. 8C, article 200e from FIGS. 8A-8B has been arranged at interface 130 between first layer 132 and second layer 134 of a solid body. The first layer and/or the second layer of the multi-layer article may comprise any of a variety of materials described elsewhere herein.

According to some embodiments, and as shown in FIG. 8C, a surface of first electrode 220 of capacitor 202 that faces second electrode 222 of capacitor 202 is substantially parallel to interface 130 between first layer 132 and second layer 134. In addition, a surface of second electrode 222 of capacitor 202 that faces first electrode 220 of capacitor 202 is substantially parallel to interface 130 between first layer 132 and second layer 134.

In some embodiments, and as shown in FIG. 8C, a surface of first electrode 230 of capacitor 206 that faces second electrode 232 of capacitor 206 is substantially parallel to interface 130 between first layer 132 and second layer 134. In addition, a surface of second electrode 232 of capacitor 206 that faces first electrode 230 of capacitor 206 is substantially parallel to interface 130 between first layer 132 and second layer 134.

According to certain embodiments, and as shown in FIG. 8C, non-conductive material 111 is in the form of a layer that is in contact with and substantially parallel to interface 130 between first layer 132 and second layer 134. In addition, capacitor 202 of the first circuit substantially surrounds capacitor 206 of the second circuit. In the embodiment shown in FIG. 8C, as a crack propagates through interface 130, it will come into contact with non-conductive material 111, and further crack propagation between first electrode 220 and second electrode 222 will be energetically favored relative to crack propagation elsewhere in the composite. Moreover, crack propagation between electrode 220 and electrode 222 will happen before crack propagation occurs between electrode 230 and electrode 232. As the crack propagates between electrodes 220 and 222, the capacitance of capacitor 202 will change while the capacitance of capacitor 206 will not change. By comparing the signals generated by capacitors 202 and 206 under these conditions, one can determine the portion of the change that is attributable to crack propagation and the portion of the change that is attributable to other environmental factors (e.g., temperature, humidity, strain, creep, aging, etc.).

In some embodiments, and as shown in FIG. 8C, a crack cannot propagate from point 290 (which is in the interlaminar region of the multi-layer article within which the first and second circuits are located) to inductor 204 without passing through non-conductive region 211, through layer 132, or through layer 134. The second circuit is arranged similarly, such that a crack cannot propagate from point 290 (which is in the interlaminar region of the multi-layer article within which the first and second circuits are located) to inductor 208 without passing through non-conductive region 211, through layer 132, or through layer 134.

According to certain embodiments, and as shown in FIG. 8C, it is not possible for a crack to propagate from point 290 to inductor 208 or to capacitor 206 without passing through non-conductive region 211, through the bulk of layer 132, or through the bulk of layer 134.

According to some embodiments, article 200e may comprise a structural defect (e.g., a crack) in non-conductive material 111 that has propagated from point 290. In some embodiments, the distance between electrodes 220 and 222 of capacitor 202 may be increased relative to the distance between electrodes 230 and 232 of capacitor 206, causing a change in the capacitance of capacitor 202 without a change in the capacitance of capacitor 206. In some embodiments, a user comparing the signals generated by capacitors 202 and 206 can determine the portion of the change that is attributable to crack propagation and the portion of the change that is attributable to other environmental factors (e.g., temperature, humidity, strain, creep, aging, etc.).

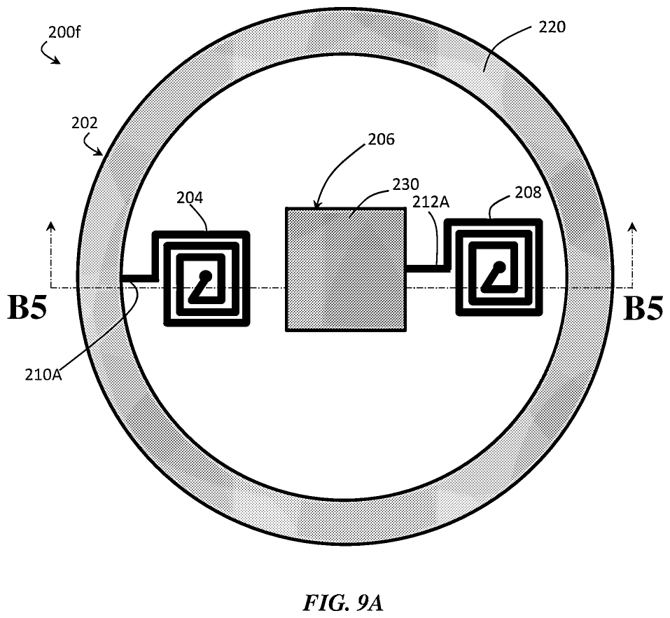

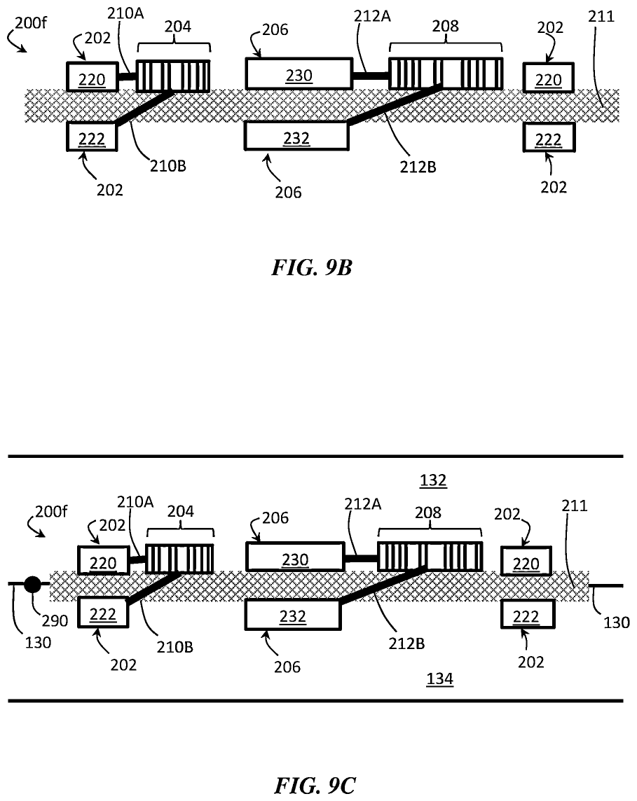

As described in further detail herein, at least one capacitor of an article comprising multiple circuits may have a square shape. For example, FIG. 9A is a top-view schematic illustration of article 200f comprising a first circuit comprising capacitor 202 and inductor 204 and a second circuit comprising capacitor 206 and inductor 208, wherein capacitor 206 of the second circuit has a square shape, and FIG. 9B is a cross-sectional schematic illustration of article 200f taken along Section B5-B5 of FIG. 9A. Article 200f otherwise functions the same as article 200e shown in and described in relation to FIGS. 8A-8B, while also providing the benefits described above with respect to the RLC circuit shown in and described in relation to FIGS. 3A-3B.

Although the embodiment in FIG. 9A shows that the capacitor of the first circuit has a circular shape and the capacitor of the second circuit has a square shape, the capacitor of the first circuit may, in some embodiments, have a square shape instead of, or in addition to, the second circuit having a square shape.

According to some embodiments, article 200f shown in FIGS. 9A-9B may be located in an interlaminar region of a multi-layer article. For example, in some embodiments, article 200f may be located at an interface between a first layer and a second layer of a solid body. One example of this is illustrated in FIG. 9C. In some embodiments, article 200f located at an interface between a first layer and a second layer of a solid body may function the same as article 200e shown in and described in relation to FIG. 8C.

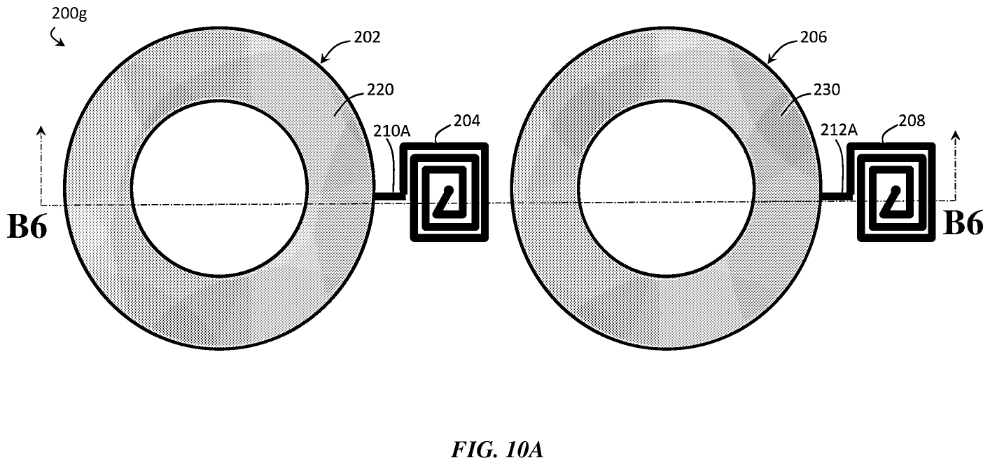

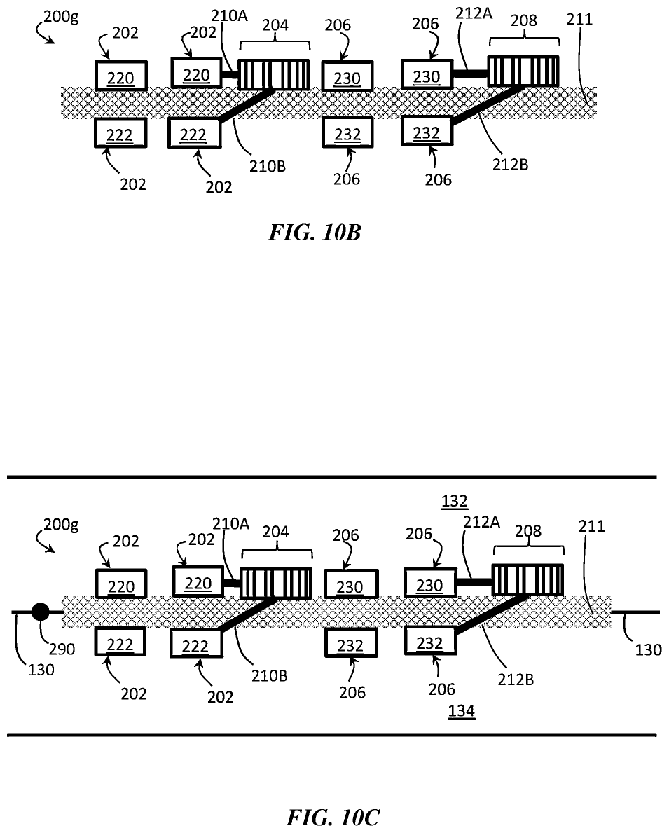

Yet another example of an article comprising multiple circuits is illustrated in FIGS. 10A-10B. FIG. 10A is a top-view schematic illustration of article 200g, and FIG. 10B is a cross-sectional schematic illustration of article 200g taken along Section B6-B6 of FIG. 10A. In FIG. 10A, article 200g comprises a first circuit comprising capacitor 202 and inductor 204 and a second circuit comprising capacitor 206 and inductor 208. Capacitor 202 is electronically coupled to inductor 204 via electronically conductive pathways 210A and 210B and capacitor 206 is electronically coupled to inductor 208 via electronically conductive pathways 212A and 212B. In addition, each of the first and second circuits can be associated with a solid body, such as a multi-layer material.

As illustrated in FIGS. 10A-10B, capacitors 202 and 206 are parallel-plate capacitors. Capacitor 202 comprises first electrode 220 and second electrode 222 (hidden from view in FIG. 10A by electrode 220). Capacitor 206 comprises first electrode 230 and second electrode 232 (hidden from view in FIG. 10A by electrode 230). In other embodiments, as described elsewhere herein, capacitor 202 may be a parallel-plate capacitor and capacitor 206 may be an interdigitated capacitor.

As described elsewhere herein, in some embodiments, the electrodes of the capacitor can comprise electronically conductive nanostructures (e.g., electronically conductive elongated nanostructures, such as carbon nanotubes) embedded within a non-conductive (e.g., electrically insulating) matrix. The nanostructures within the capacitor can be used, for example, to provide mechanical reinforcement between the capacitor electrode and adjacent structures (e.g., a layer of a multi-layer composite).

Capacitor 202 further comprises non-conductive material 211 between first electrode 220 and second electrode 222. Non-conductive material 211 is also used to physically separate first electrode 230 of capacitor 206 from second electrode 232 of capacitor 206. In some embodiments, it is advantageous to use a single non-conductive material layer to separate the electrodes of both the first and second capacitors, as shown in FIGS. 10A-10B, but in other embodiments, multiple non-conductive material layers can be used. Any of the non-conductive material types mentioned elsewhere herein can be used for non-conductive material 211.

In the embodiment illustrated in FIG. 10A, both inductor 204 and inductor 208 comprise an electronically conductive pathway arranged in a spiral shape, although other shapes and/or configurations are possible. As described elsewhere herein, in some embodiments, the inductors can comprise electronically conductive nanostructures (e.g., electronically conductive elongated nanostructures, such as carbon nanotubes) embedded within a non-conductive (e.g., electrically insulating) matrix. The nanostructures within the inductor can be used, for example, to provide mechanical reinforcement between the inductor and adjacent structures (e.g., a layer of a multi-layer composite).

In the embodiment shown in FIGS. 10A-10B, inductor 204 is electronically coupled to capacitor 202 via electronically conductive pathways 210A and 210B. In particular, electronically conductive pathway 210A electronically couples one end of inductor 204 to electrode 220 of capacitor 202, and electronically conductive pathway 210B electronically couples a second end of inductor 204 (illustrated in FIG. 10A as a solid black circle) to electrode 222 of capacitor 202. When connected in this fashion, the capacitor and the inductor of the first circuit can form an RLC circuit, such as the circuit illustrated in the right-hand side of FIG. 12. In some embodiments, a dedicated resistor can be incorporated into the first circuit. In other embodiments, the intrinsic electrical resistivity of the circuit elements and/or the electronically conductive pathways coupling the circuit elements to each other can serve as the resistor of the RLC circuit.

Also, in the embodiment shown in FIGS. 10A-10B, inductor 208 is electronically coupled to capacitor 206 via electronically conductive pathways 212A and 212B. In particular, electronically conductive pathway 212A electronically couples one end of inductor 208 to electrode 230 of capacitor 206, and electronically conductive pathway 212B electronically couples a second end of inductor 208 (illustrated in FIG. 10A as a solid black circle) to electrode 232 of capacitor 206. When connected in this fashion, capacitor 206 and inductor 208 can also form an RLC circuit, such as the circuit illustrated in the left-hand side of FIG. 12. In some embodiments, a dedicated resistor can be incorporated into the circuit. In other embodiments, the intrinsic electrical resistivity of the circuit elements and/or the electronically conductive pathways coupling the circuit elements to each other can serve as the resistor of the RLC circuit.

In some embodiments related to multi-circuit embodiments, the first circuit may be positioned adjacent to the second circuit. Referring to FIG. 10A, for example, the first circuit is positioned adjacent to the second circuit.

According to certain embodiments, the capacitor and the inductor of the first circuit may be arranged such that the capacitor of the first circuit is positioned alongside (e.g., adjacent to) the inductor of the first circuit, and the capacitor and the inductor of the second circuit may be arranged such that the capacitor of the second circuit is positioned alongside (e.g., adjacent to) the inductor of the second circuit. Referring to FIGS. 10A-10B, for example, capacitor 202 of the first circuit is positioned alongside (e.g., adjacent to) inductor 204 of the first circuit, and capacitor 206 of the second circuit is positioned alongside (e.g., adjacent to) inductor 208 of the second circuit. Arranging the circuits in this fashion can provide the benefits described above with respect to the RLC circuit shown in and described in relation to FIGS. 2A-2C.

According to some embodiments article 200g shown in FIGS. 10A-10B may be located in an interlaminar region of a multi-layer article. For example, in some embodiments, article 200g may be located at an interface between a first layer and a second layer of a solid body. One example of this is illustrated in FIG. 10C. In FIG. 10C, article 200g from FIGS. 10A-10B has been arranged at interface 130 between first layer 132 and second layer 134 of a solid body. The first layer and/or the second layer of the multi-layer article may comprise any of a variety of materials described elsewhere herein.

According to some embodiments, and as shown in FIG. 10C, a surface of first electrode 220 of capacitor 202 that faces second electrode 222 of capacitor 202 is substantially parallel to interface 130 between first layer 132 and second layer 134. In addition, a surface of second electrode 222 of capacitor 202 that faces first electrode 220 of capacitor 202 is substantially parallel to interface 130 between first layer 132 and second layer 134.

In some embodiments, and as shown in FIG. 10C, a surface of first electrode 230 of capacitor 206 that faces second electrode 232 of capacitor 206 is substantially parallel to interface 130 between first layer 132 and second layer 134. In addition, a surface of second electrode 232 of capacitor 206 that faces first electrode 230 of capacitor 206 is substantially parallel to interface 130 between first layer 132 and second layer 134.

According to certain embodiments, and as shown in FIG. 10C, non-conductive material 111 is in the form of a layer that is in contact with and substantially parallel to interface 130 between first layer 132 and second layer 134. In addition, capacitor 202 of the first circuit substantially surrounds capacitor 206 of the second circuit. In the embodiment shown in FIG. 10C, as a crack propagates through interface 130, it will come into contact with non-conductive material 111, and further crack propagation between first electrode 220 and second electrode 222 will be energetically favored relative to crack propagation elsewhere in the composite. Moreover, crack propagation between electrode 220 and electrode 222 will happen before crack propagation occurs between electrode 230 and electrode 232. As the crack propagates between electrodes 220 and 222, the capacitance of capacitor 202 will change while the capacitance of capacitor 206 will not change. By comparing the signals generated by capacitors 202 and 206 under these conditions, one can determine the portion of the change that is attributable to crack propagation and the portion of the change that is attributable to other environmental factors (e.g., temperature, humidity, strain, creep, aging, etc.).

In some embodiments, and as shown in FIG. 10C, a crack cannot propagate from point 290 (which is in the interlaminar region of the multi-layer article within which the first and second circuits are located) to inductor 204 without passing through non-conductive region 211, through layer 132, or through layer 134. The second circuit is arranged similarly, such that a crack cannot propagate from point 290 (which is in the interlaminar region of the multi-layer article within which the first and second circuits are located) to inductor 208 without passing through non-conductive region 211, through layer 132, or through layer 134.

According to certain embodiments, and as shown in FIG. 10C, it is not possible for a crack to propagate from point 290 to inductor 208 or to capacitor 206 without passing through non-conductive region 211, through the bulk of layer 132, or through the bulk of layer 134.

According to some embodiments, article 200g may comprise a structural defect (e.g., a crack) in non-conductive material 111 that has propagated from point 290. In some embodiments, the distance between electrodes 220 and 222 of capacitor 202 may be increased relative to the distance between electrodes 230 and 232 of capacitor 206, causing a change in the capacitance of capacitor 202 without a change in the capacitance of capacitor 206. In some embodiments, a user comparing the signals generated by capacitors 202 and 206 can determine the portion of the change that is attributable to crack propagation and the portion of the change that is attributable to other environmental factors (e.g., temperature, humidity, strain, creep, aging, etc.).

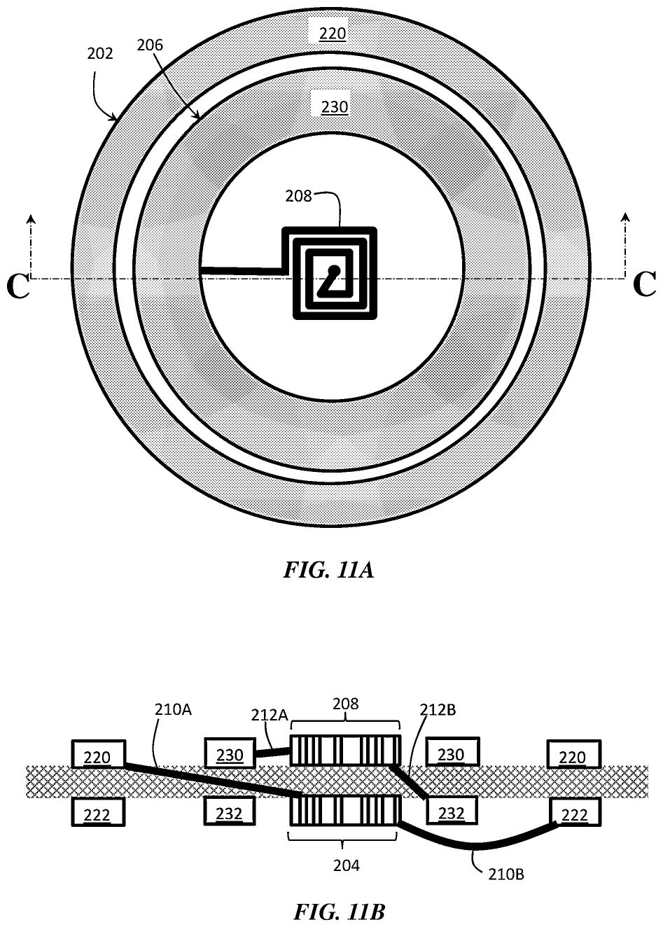

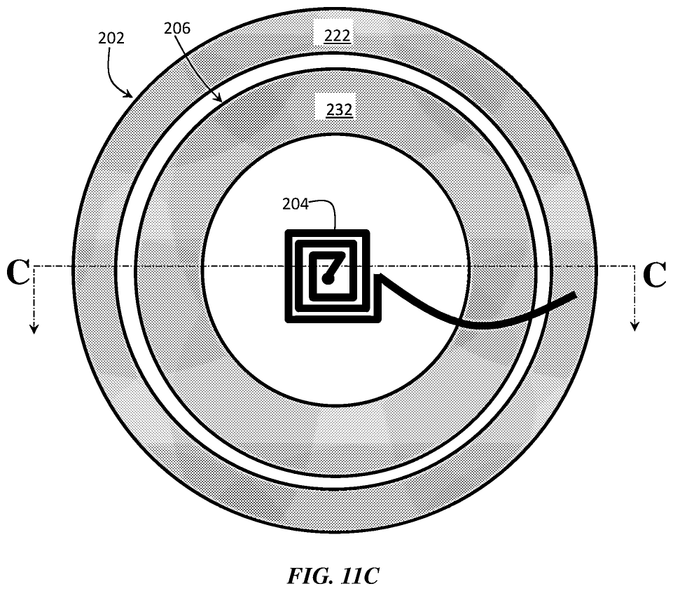

FIGS. 11A-11C illustrate an alternative embodiment of a multi-circuit article. FIG. 11A is a top-view schematic illustration of the multi-circuit article, FIG. 11B is a cross-sectional schematic illustration taken along Section C-C of FIG. 11A, and FIG. 11C is a bottom-view schematic illustration of the multi-circuit article. In the article of FIGS. 11A-11C, the capacitor of the first circuit still substantially surrounds the inductor of the first circuit, the capacitor of the second circuit, and the inductor of the second circuit. However, the inductor of the first circuit does not substantially surround the inductor of the second circuit or the capacitor of the second circuit. Instead, each of the inductors of the first circuit and the second circuit are substantially surrounded by both the capacitor of the first circuit and the capacitor of the second circuit, with the inductor of the first circuit being located on one side of the non-conductive material region and the inductor of the second circuit being located on a second, opposite side of the non-conductive material region.

In some embodiments comprising a first circuit and second circuit, it can be particularly advantageous to use a first circuit comprising a capacitor that completely surrounds the inductor of the first circuit and a second circuit comprising a capacitor that completely surrounds the inductor of the second circuit. It can also be particularly advantageous to arrange the circuits such that the capacitor of the first circuit completely surrounds the capacitor of the second circuit and the inductor of the second circuit. In some embodiments, arrangements such as these can reduce the chances that the first circuit and the second circuit will be exposed to different environmental conditions (and, thus, make it easier to compensate for those environmental conditions when readings are taken). As one non-limiting example, in some cases where the capacitors do not completely surround inductors, the two circuits might be exposed to similar but different local environmental conditions (e.g., temperature, humidity, strain etc.) due to the open portion of the capacitor, which can result in the compensation algorithm over or under compensating for the environmental contribution to the signal.

In some embodiments, it can be advantageous to use, in the capacitor of the first circuit and/or in the capacitor of the second circuit, electrodes that exhibit a high degree of overlap between their capacitive surfaces (i.e., the surfaces of the electrode capacitors that face each other and are separated by the non-conductive material). For example, in some embodiments, the capacitor of the first circuit and/or the capacitor of the second circuit can be arranged such that, for each of the electrodes, there is at least 90%, at least 95%, at least 98%, at least 99%, or 100% overlap between the capacitive surface of the electrode and the capacitive surface of the counter electrode. As examples, all of the capacitors illustrated in FIGS. 1A-1C, 1E, 1H, 2A-2C, 3A-3C, 4A-4C, 5A-5C, 6A-6C, 7A-7C, 8A-8C. 9A-9C, 10A-10C, and 11A-11C are arranged such that each electrode of each capacitor has 100% overlap between its capacitive surface and the capacitive surface of the counter electrode. Arranging the capacitors in this way can lead to further improvement in compensating for environmental impacts on the sensor signal.

As noted above, in some embodiments, the circuits described herein can be used as RLC circuits. FIG. 16 is a schematic illustration showing one mode of operation, in which resonant inductive pulse-echo methods are employed.

The idea of the Pulse-Echo non-invasive sensor architecture, in accordance with certain embodiments, is to keep the embedded sensing circuit as simple as possible and move the complexity to the reader. The measurement approach is, in accordance with certain embodiments, “pulse echo.” In such embodiments, the reader can apply a drive waveform to power the resonator(s). In some embodiments, the drive waveform is subsequently removed for detection. After removing the drive waveform, the circuit(s) can generate a signal (e.g., a decaying signal in a frequency of the capacitance and the inductor), which can be used to determine a mechanical characteristic of the solid body with which the circuits are associated. In some embodiments, determining the mechanical characteristic of the material comprises determining whether a mechanical transformation has occurred in the material; determining the type of mechanical transformation that has occurred in the material; determining whether a structural defect (e.g., a crack, a hole, a delamination, etc.) is present within the material; and/or determining the type of structural defect that is present within the material. As one example, some embodiments comprise determining whether a mechanical transformation has occurred within the structure within which the sensor has been integrated. For example, in accordance with some embodiments, if a mechanical transformation has occurred in the article containing the sensor, the signal that is returned to the reader by the circuit(s) exhibits a change in resonance frequency; but if a mechanical transformation has not occurred in the article containing the sensor, the signal that is returned to the reader by the sensor does not exhibit a change in resonance frequency. In some embodiments, the measured parameter will change the inductance value. As one example, the Reader can use, in some embodiments, ADC to sample the information and can perform a finite Fourier transform (FFT) to estimate the resonator frequency shift/change and map it to a mechanical transformation (e.g., a delamination, a strain, and/or a crack).

Any of a variety of mechanical transformations and/or structural defects of the composite may be detected using the sensor, including delaminations, strains, cracks, holes, and the like. The sensing principle for detecting the mechanical transformation may be any one of several options, including a piezoresistive change in strain, a resonant shift due to change in modulus or strain, a piezoelectric sensor change in strain, etc. Various configurations of sensing elements and electronics (structural electronics) elements exist.

The following examples are intended to illustrate certain embodiments of the present invention, but do not exemplify the full scope of the invention.

### Example 1

This example describes the use of RLC circuits in which a parallel-plate capacitor is positioned alongside (e.g., adjacent to) an inductor to wirelessly power and detect delamination between two layers of a multi-layer article using: (i) capacitance change in a wired configuration, and (ii) wireless echo signal frequency change from the RLC circuit. The capacitance change in the wired configuration and the wireless echo frequency change from the RLC circuit are both associated with the change in delamination crack length.

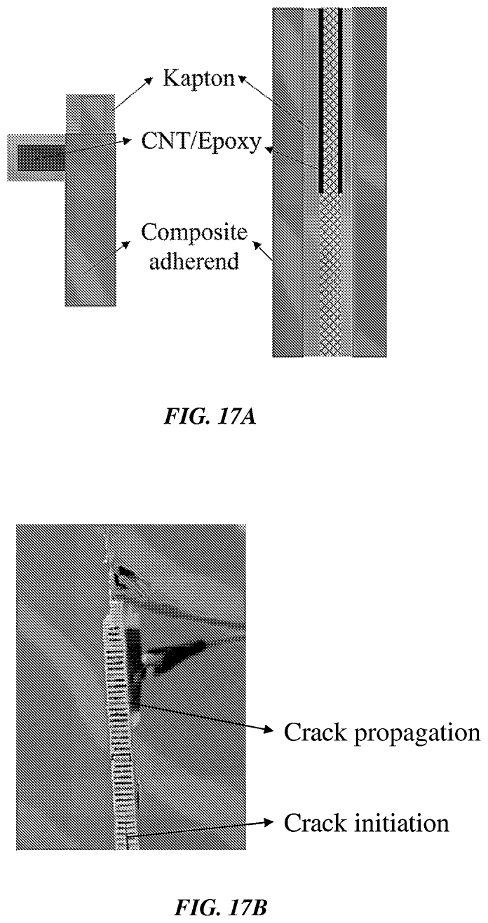

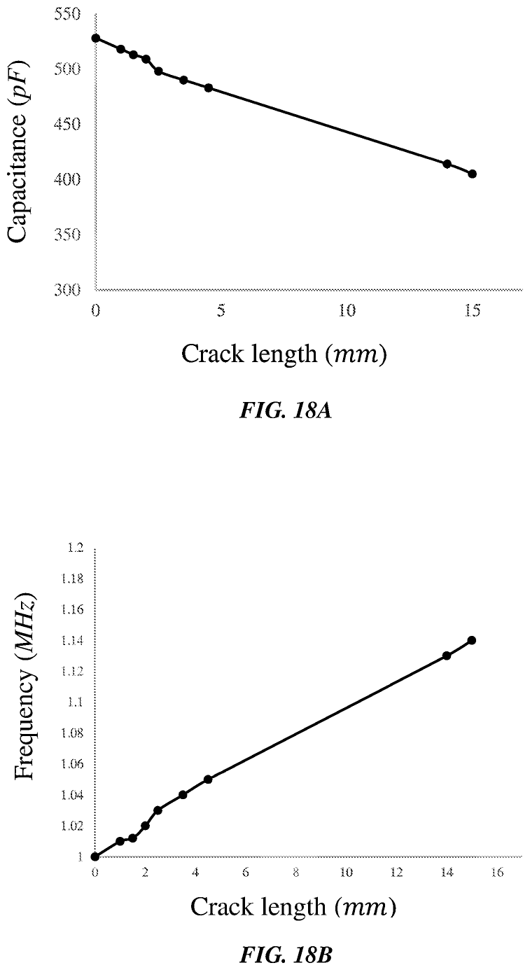

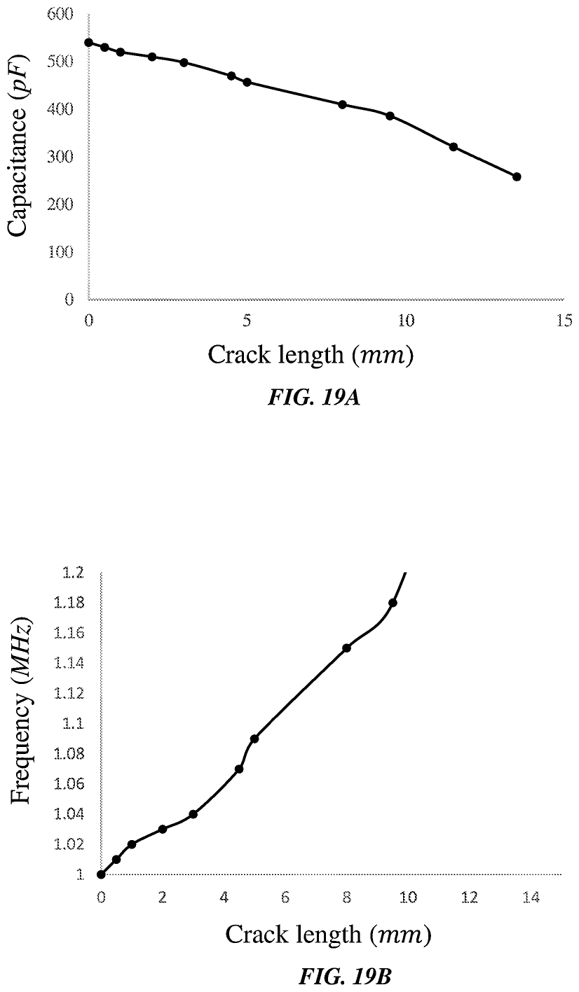

To measure the capacitance change in the wired configuration, sensors similar to that shown in FIG. 3A were fabricated utilizing elongated carbon nanotubes and epoxy polymer, thereby forming parallel-plate capacitor sensors. The sensors were embedded between two composite substrates (see FIG. 17A) with a Teflon crack starter to allow a crack to be propagated in Mode I (standard fracture test), as shown in FIG. 17B. Crack length was measured on the edge of the articles using paint and graded markings, wherein each graded marking designates a millimeter. Capacitance was measured, and the change in capacitance as a function of crack length is shown for two samples in FIGS. 18A and 19A. The change in frequency as a function of crack length was determined from the change in capacitance, as shown in FIGS. 18B and 19B.

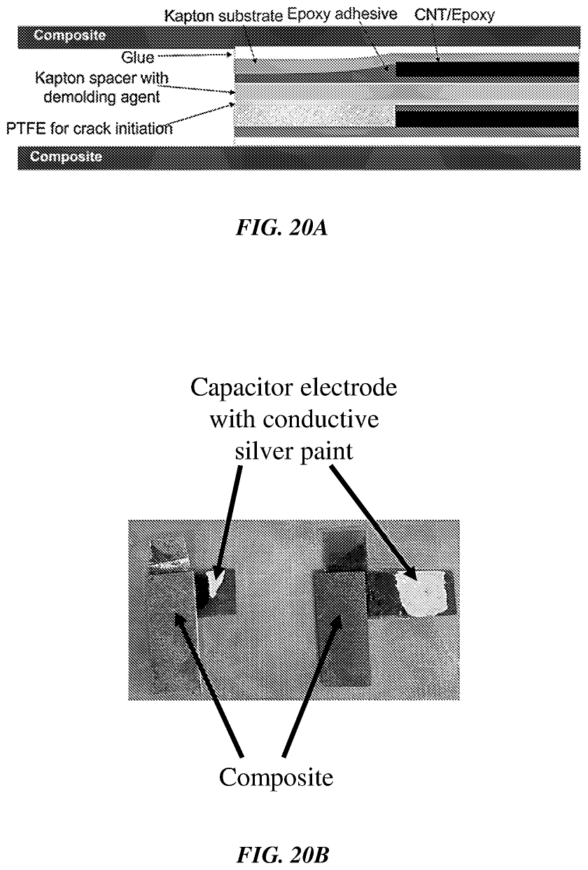

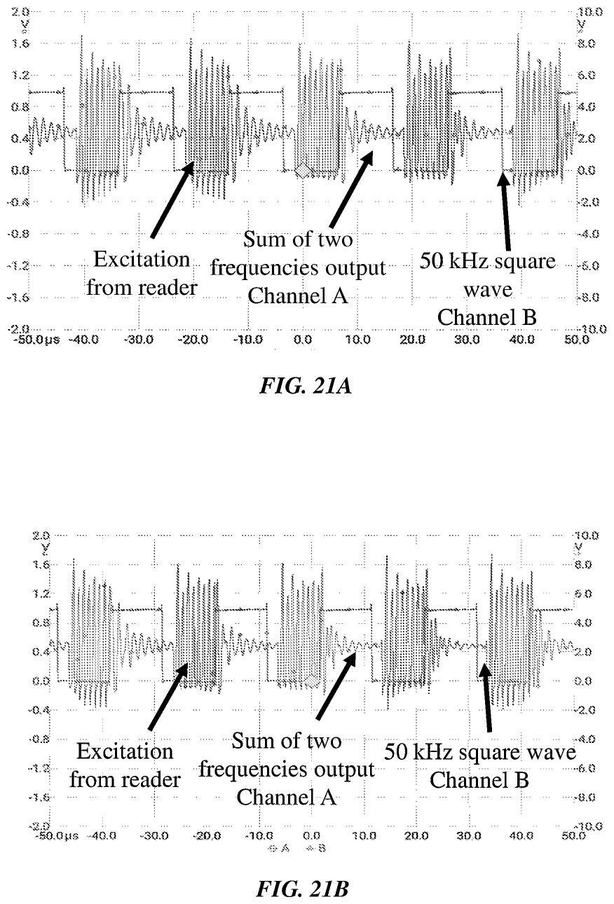

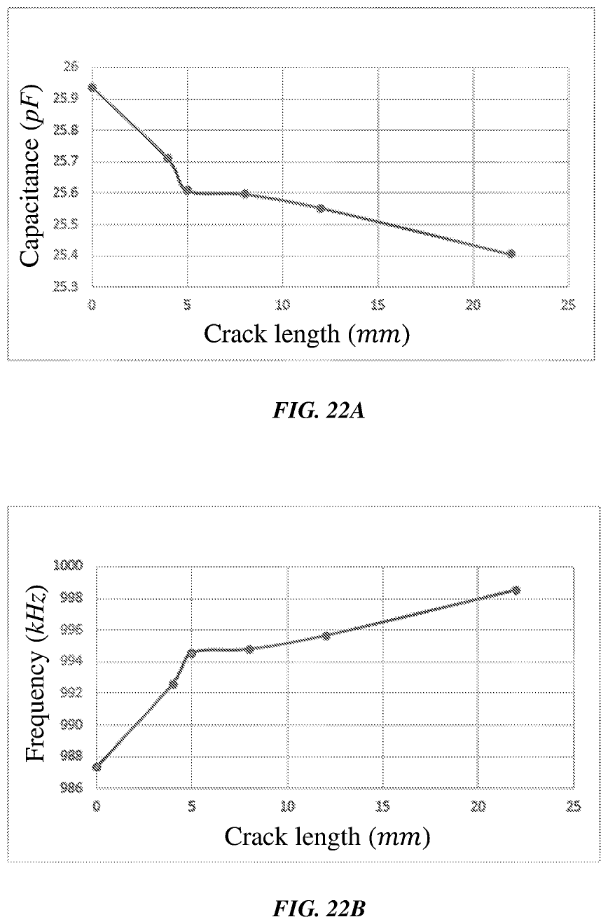

To measure the wireless echo signal frequency change from the RLC circuit, a sensor was fabricated and tested as described above except a commercial off-the-shelf inductor was used to obtain an LC resonant frequency of ˜1 MHz. The LC sensor is shown in FIGS. 20A-20B. As the crack propagated, the frequency changed due to the crack causing a change in capacitance, as shown in FIGS. 21A-21B. The capacitance and frequency change as a function of crack length was determined (see FIGS. 22A and 22B, respectively).

### Prophetic Example 1

This example describes the use of RLC circuits to detect delamination between two layers of a multi-layer article using circuits in which the capacitor substantially surrounds the inductor. This example also describes the use of multiple, nested sensors arranged such that the capacitor of one of the sensors substantially surrounds the capacitor and the inductor of the other sensor, which can be used to compensate for environmental conditions other than crack propagation (e.g., related to temperature, humidity, strain, creep, aging, etc.).

The idea of the CNT Delamination Sensor with environmental compensation architecture is to keep the embedded sensing element as simple as possible (e.g., wireless and wirelessly powered to avoid connections that cause damage and material mismatch). The sensors use RLC structural electronics components to create one or more resonators.

The sensing element allows one to measure the progression of a crack in a solid body at an interface between two layers (e.g., a delamination between two layers, a crack at any location in which the sensor circuits are located and in any orientation of crack growth in the interface). To obtain a true measurement of delamination crack presence and/or growth, the sensing element should compensate for all environmental conditions such as temperature, humidity, strain, creep, aging, etc.

The delamination sensing element for a structural health monitoring (SHM) circuit comprises an inductor and a capacitor electronically coupled to the inductor to create a sensing resonator. One arrangement is similar to the arrangement shown in FIGS. 1A-1B. In this arrangement, the sensor capacitor surrounds the inductor and the electronic connections between the inductor and the capacitor (see FIG. 1A).

In another arrangement, a second circuit is incorporated in which the capacitor and the inductor of the second circuit surrounds the inductor and capacitor of the first circuit, similar to the arrangement shown in FIGS. 4A-4C. In this arrangement, the first circuit (e.g., comprising capacitor 202 and inductor 204 in FIG. 4A is used as a sensing circuit and the second circuit (e.g., comprising capacitor 206 and inductor 208) is used as a reference circuit. The sensing circuit capacitor completely surrounds the reference circuit inductor, the reference circuit capacitor, and the sensing circuit inductor, which allows for environmental compensation.

The sensing circuit resonator allows the sensing circuit to monitor a formation of delamination crack at any location and in any orientation while keeping the sensing circuit operational. The delamination crack is measured using:

$$Δ f\_crack = f - {f}_{0}$$

where f is the resonator frequency of the sensing circuit and f₀ is the resonator base frequency of the sensing circuit before it has been installed. Due to the fact that the reference circuit is embedded within the sensing circuit, and both the sensing circuit and the reference circuit are exposed to the same environmental conditions (temperature, humidity, strain, and aging) the reference circuit allows one to compensate the frequency shift in the sensing circuit that can be attributed to environmental conditions, leaving only the contribution to the measurement attributable to delamination crack. One advantage of this approach is that it does not require an estimation of or independent compensation for any environmental contributions (e.g., temperature, humidity, strain, aging, etc.) other than crack propagation.

The environmental compensation can be achieved as follows. During sensor fabrication or at any other time prior to installation, a sensor calibration can be performed to measure:
f₀: the environmental free base frequency of the sensing circuit; and
fᵣ₀: the environmental free base frequency of the reference circuit.

After the sensor is installed and the sensor is interrogated to read its current sensing circuit frequency (f) and the reference circuit frequency (fᵣ), f reflects a value that is impacted by both environmental conditions and any delamination cracks formed between the capacitor electrodes of the sensing circuit, and fᵣ reflects a value that is impacted only by environmental conditions.

The compensated Δf_{rc} environmental free frequency shift is calculated as:

$$Δ {f}_{crack} = f - {f}_{r} \sqrt{\frac{{c}_{1}}{{c}_{2}}} = f - {f}_{r} \frac{{f}_{0}}{{f}_{r , 0}}$$

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of.” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “cither.” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B.” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An article, comprising:
a solid body; and
a circuit associated with the solid body, the circuit comprising:
an inductor; and
a capacitor electronically coupled to and substantially surrounding the inductor.

2. The article of claim 1, wherein the circuit is an RLC circuit.

3. The article of claim 1, wherein the inductor comprises patterned elongated nanostructures that serve an electronic function of the inductor.

4. The article of claim 1, wherein the capacitor comprises patterned elongated nanostructures that serve an electronic function of the capacitor.

5. The article of claim 3, wherein the elongated nanostructures comprise carbon nanotubes.

6. The article of claim 1, wherein the capacitor is a parallel plate capacitor comprising a first electrode and a second electrode.

7. The article of claim 6, wherein the first electrode and the second electrode of the parallel plate capacitor each substantially surround the inductor.

8. The article of claim 1, wherein:
the solid body comprises a first layer and a second layer, the first layer and the second layer defining an interface; and
the circuit is located at the interface between the first layer and the second layer.

9. The article of claim 8, wherein:
a surface of the first electrode that faces the second electrode is substantially parallel to the interface between the first layer and the second layer, and
a surface of the second electrode that faces the first electrode is substantially parallel to the interface between the first layer and the second layer.

10. The article of claim 8, wherein:
a first electrode of the capacitor comprises patterned elongated nanostructures that serve an electronic function of the capacitor and penetrate into the first layer to mechanically reinforce an interface between the first electrode of the capacitor and the first layer; and
a second electrode of the capacitor comprises patterned elongated nanostructures that serve an electronic function of the capacitor and penetrate into the second layer to mechanically reinforce an interface between the second electrode of the capacitor and the second layer.

11. The article of claim 8, wherein the inductor comprises patterned elongated nanostructures that serve an electronic function of the inductor and penetrate into the first layer to mechanically reinforce an interface between the inductor and the first layer.

12. The article of claim 1, wherein the circuit is part of a structure laminated to an external surface of the solid body.

13. An article, comprising:
a solid body;
a first circuit associated with the solid body, the first circuit comprising an inductor and a capacitor electronically coupled to the inductor; and
a second circuit associated with the solid body, the second circuit comprising an inductor and a capacitor electronically coupled to the inductor;
wherein the capacitor of the first circuit substantially surrounds the inductor of the second circuit and the capacitor of the second circuit.

14. The article of claim 13, wherein the capacitor of the first circuit completely surrounds the inductor of the second circuit and the capacitor of the second circuit.

15. (canceled)

16. The article of claim 13, wherein the capacitor of the first circuit completely surrounds the inductor of the first circuit.

17-18. (canceled)

19. The article of claim 13, wherein the inductor of the first circuit comprises patterned elongated nanostructures that serve an electronic function of the inductor of the first circuit.

20-40. (canceled)

41. An article, comprising:
a solid body comprising a first layer and a second layer, the first layer and the second layer defining an interface;
a first circuit located at the interface between the first layer and the second layer, the first circuit comprising:
an inductor; and
a parallel-plate capacitor coupled to the inductor, the parallel-plate capacitor comprising a first electrode, a second electrode, and a non-conductive material between the first electrode and the second electrode, wherein a surface of the first electrode that faces the second electrode is substantially parallel to the interface between the first layer and the second layer, and a surface of the second electrode that faces the first electrode is substantially parallel to the interface between the first layer and the second layer; and
a second circuit located at the interface between the first layer and the second layer, the second circuit comprising:
an inductor; and
a parallel-plate capacitor coupled to the inductor, the parallel-plate capacitor comprising a first electrode, a second electrode, and a non-conductive material between the first electrode and the second electrode, wherein a surface of the first electrode that faces the second electrode is substantially parallel to the interface between the first layer and the second layer, and a surface of the second electrode that faces the first electrode is substantially parallel to the interface between the first layer and the second layer;
wherein the first electrode of the parallel plate capacitor of the first circuit and the second electrode of the parallel plate capacitor of the first circuit each substantially surround the inductor, the first electrode, and the second electrode of the second circuit.

42-49. (canceled)

50. The article of claim 1, wherein the circuit is a first circuit, and the article further comprises:
a second circuit associated with the solid body, the second circuit comprising an inductor and a capacitor electronically coupled to the inductor,
wherein the capacitor of the first circuit substantially surrounds the inductor of the second circuit and the capacitor of the second circuit.

51. The article of claim 50, wherein the second circuit is a reference circuit configured to allow a user to correct for changes to and/or differences in an environment of the article when taking a measurement from the first circuit.

52. The article of claim 13, wherein the second circuit is a reference circuit configured to allow a user to correct for changes to and/or differences in an environment of the article when taking a measurement from the first circuit.
